(19) United States
(12) Patent Application Publication
(10) Pub. No.: US 2026/0219929 A1
(43) Pub. Date: Jul. 30, 2026

(54) CONTEXT-AWARE TASK ALLOCATION AND REPUTATION MANAGEMENT FOR ARTIFICIAL INTELLIGENCE AGENTS

(71) Applicant: Cisco Technology, Inc., San Jose, CA (US)

(72) Inventor: Dennis Lanov, Richardson, TX (US)

(21) Appl. No.: 19/041,968

(22) Filed: Jan. 30, 2025

(51) Int. Cl. G06F 9/50; G06N 20/00; H04L 9/00

(52) U.S. Cl. CPC G06F 9/5005; G06N 20/00; H04L 9/50; G06F 2209/501; G06F 2209/508

(57) ABSTRACT

Devices and methods for context-aware task allocation and reputation management for Artificial Intelligence (AI) agents are provided. Existing task management frameworks may fall short in effectively assigning tasks to AI agents for execution in dynamic, unpredictable, and interdependent environments. Thus, a task management device that can dynamically assign tasks to AI agents is provided. The task management device may receive a task and determine one or more contextual features associated with the task. The task management device may obtain a set of task execution proposals from a subset of AI agents that align with the determined one or more contextual features and evaluate the obtained set of task execution proposals against one or more evaluation parameters. The task management device may select at least one AI agent from the subset of AI agents based on the evaluation and assign the received task to the selected at least one AI agent.

The present disclosure relates to Artificial Intelligence (AI)-based systems. More particularly, the present disclosure relates to context-aware task allocation and reputation management mechanisms for AI agents within a distributed network infrastructure.

### BACKGROUND

Effective task management and distribution are key components in optimizing the performance of Artificial Intelligence (AI) agents in environments with high variability and complexity. As AI continues to be integrated into diverse applications, ranging from industrial automation to data analysis, effective task management becomes increasingly important to ensure that AI agents can operate efficiently in dynamic environments.

Over the past few years, several task management frameworks, such as label-based distribution, rule-based reputation assessment, and centralized task management, have been developed. In label-based distribution framework, tasks are assigned to AI agents according to predefined categories or labels, while rule-based reputation assessment framework is employed to evaluate the performance of AI agents using fixed criteria, such as task completion time or success rate. In centralized task management, a central entity is responsible for distributing tasks to AI agents. While these frameworks have demonstrated utility in structured and predictable contexts, they may fall short in environments that are dynamic, unpredictable, and interdependent. In such complex environments, conditions change rapidly, tasks are interlinked, and systems are required to integrate diverse components to operate effectively. These scenarios also involve incomplete information and scalability challenges, requiring continuous adaptation and efficient coordination. As a result, existing frameworks lack flexibility, leading to suboptimal task assignments and inefficient use of resources.

### SUMMARY OF THE DISCLOSURE

Devices and methods for context-aware task allocation and reputation management mechanisms for AI agents in accordance with embodiments of the disclosure are described herein. In many embodiments, a task management device may include a processor, a network interface controller configured to provide access to a network, and a memory communicatively coupled to the processor. The memory may include a task optimization logic that may be configured to receive a task. The task management device may further be configured to determine one or more contextual features associated with the task and obtain a set of task execution proposals from a subset of AI agents, among a plurality of AI agents, that align with the determined one or more contextual features. Furthermore, the task management device may be configured to evaluate the obtained set of task execution proposals against one or more evaluation parameters, select at least one AI agent from the subset of AI agents based on the evaluation of the set of task execution proposals, and assign the received task to the selected at least one AI agent.

In a number of embodiments, the task optimization logic may be further configured to identify, from the plurality of AI agents, the subset of AI agents based on the determined one or more contextual features, and transmit a query to the identified subset of AI agents for submission of the set of task execution proposals for the received task, where the set of task execution proposals may be obtained as a response from the subset of AI agents for the transmitted query.

In a variety of embodiments, the task optimization logic may be further configured to monitor an execution of the assigned task by the selected at least one AI agent, receive a task execution result from the at least one AI agent based on the execution of the assigned task, determine a performance score for the at least one AI agent based on the received task execution result and one or more determination parameters, and update a reputation score of the selected at least one AI agent based on the determined performance score.

In various embodiments, the task optimization logic may be further configured to store the updated reputation score of the at least one AI agent on a distributed ledger.

In more embodiments, the distributed ledger may correspond to a blockchain-based database.

In additional embodiments, the one or more determination parameters may include one or more of an actual task execution time or an actual resource efficiency.

In further embodiments, the task optimization logic may be further configured to validate the task execution result against one or more validation parameters, and where the determination of the performance score for the at least one AI agent may further be based on the validation of the task execution result.

In still more embodiments, the one or more validation parameters may include one or more of compliance with one or more task requirements of the task or a task execution accuracy.

In still further embodiments, the task optimization logic may be further configured to perform one or more interactions with the plurality of AI agents utilizing a smart contract.

In still additional embodiments, the one or more interactions may include at least one of a first interaction to obtain a task execution proposal of the set of task execution proposals, a second interaction to assign the received task, a third interaction to monitor the execution of the assigned task, or a fourth interaction to receive the task execution result.

In some more embodiments, the smart contract may include one or more terms and conditions associated with the task.

In yet various embodiments, the task optimization logic may be further configured to provide feedback to the selected at least one AI agent regarding the execution of the task, and where the feedback may include at least one of the performance score or the updated reputation score.

In yet more embodiments, the selected at least one AI agent may include two or more AI agents of the subset of AI agents, and where the task optimization logic may further be configured to assign the task to the two or more AI agents for parallel execution, monitor an execution of the task by each of the two or more AI agents, receive a plurality of task execution results from the two or more AI agents based on the execution of the task, compare the plurality of task execution results, and generate a final task execution result based on the comparison.

In still yet more embodiments, the task optimization logic may be further configured to determine a performance score for each of the two or more AI agents based on the final task execution result and one or more determination parameters, and update a reputation score of each of the two or more AI agents based on the determined performance score.

In many further embodiments, the one or more contextual features may correspond to at least one of a task type, one or more requirements of the task, or one or more security requirements.

In many additional embodiments, the one or more evaluation parameters may include at least one of a task execution time, a task execution cost, a resource efficiency, or a reputation score.

In still yet further embodiments, the plurality of AI agents may be deployed in a distributed network architecture.

In several embodiments, a task management device may include a processor and a memory communicatively coupled to the processor. The memory may include a task optimization logic that may be configured to receive a task comprising a plurality of subtasks, determine one or more contextual features associated with the task, obtain a set of task execution proposals from a subset of Artificial Intelligence (AI) agents, among a plurality of AI agents, that align with the determined one or more contextual features, evaluate the obtained set of task execution proposals against a plurality of evaluation parameters, select a corresponding AI agent, from the subset of AI agents, for each subtask of the plurality of subtasks based on the evaluation of the set of task execution proposals, and assign each subtask of the plurality of subtasks to the selected corresponding AI agent.

In a number of embodiments, the task optimization logic may be further configured to monitor a collaborative execution of the plurality of subtasks, receive, for each subtask of the plurality of subtasks, a subtask execution result from the selected corresponding AI agent, determine, for each subtask of the plurality of subtasks, a performance score for the corresponding AI agent based on the subtask execution result and one or more determination parameters, and update a reputation score of the corresponding AI agent based on the determined performance score.

In several other embodiments, a method may include receiving a task. The method may further include determining one or more contextual features associated with the task and obtaining a set of task execution proposals from a subset of AI agents, among a plurality of AI agents, that align with the determined one or more contextual features. Furthermore, the method may include evaluating the obtained set of task execution proposals against one or more evaluation parameters, selecting at least one AI agent from the subset of AI agents based on the evaluation of the set of task execution proposals, and assigning one of the received task or a subtask associated with the received task to the selected at least one AI agent.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic diagram of a system for context-aware task allocation and reputation management of Artificial Intelligence (AI) agents in accordance with various embodiments of the disclosure;

FIG. 2 is a detailed schematic diagram of a system for context-aware task allocation and reputation management of AI agents, illustrating interactions between various components of the system in accordance with various embodiments of the disclosure;

FIG. 3 is a schematic diagram illustrating various subsets of artificial intelligence in accordance with various embodiments of the disclosure;

FIG. 4 is a block diagram illustrating different methods of machine-based learning in accordance with various embodiments of the disclosure;

FIG. 5 is a block diagram illustrating a machine learning lifecycle in accordance with various embodiments of the disclosure;

FIG. 6 is a schematic diagram illustrating an exemplary neural network in accordance with various embodiments of the disclosure;

FIG. 7 is a flowchart depicting a process for task assignment to AI agents based on contextual features and task execution proposals in accordance with various embodiments of the disclosure;

FIG. 8 is a flowchart depicting a process for assigning a task to AI agents and monitoring task execution in accordance with various embodiments of the disclosure;

FIG. 9 is a flowchart depicting a process for assigning a task or subtasks to AI agents based on reputation scores of the AI agents in accordance with various embodiments of the disclosure;

FIG. 10 is a flowchart depicting a process for collaborative task execution involving distribution of subtasks among AI agents and updating of reputation scores of the AI agents based on performance in accordance with various embodiments of the disclosure;

FIG. 11 is a flowchart depicting a process for assigning tasks to AI agents for parallel processing, comparing task execution results, and updating reputation scores of the AI agents in accordance with various embodiments of the disclosure;

FIG. 12 is a flowchart depicting a process for assigning tasks to AI agents, validating task execution results, and updating reputation scores of the AI agents on a blockchain-based database in accordance with various embodiments of the disclosure; and

FIG. 13 is a conceptual block diagram of a device capable of executing components and a task optimization logic for implementing the functionality and embodiments described above.

Corresponding reference characters indicate corresponding components throughout the several figures of the drawings. Elements in the several figures are illustrated for simplicity and clarity and have not necessarily been drawn to scale. For example, the dimensions of some of the elements in the figures may be emphasized relative to other elements for facilitating understanding of the various presently disclosed embodiments. In addition, common, but well-understood, elements that are useful or necessary in a commercially feasible embodiment are often not depicted to facilitate a less obstructed view of these various embodiments of the present disclosure.

### DETAILED DESCRIPTION

In response to the issues described above, devices and methods are discussed herein for context-aware task allocation and reputation management of Artificial Intelligence (AI) agents within a distributed network architecture. While existing task allocation frameworks, such as label-based distribution, rule-based reputation assessment, and centralized task management, have demonstrated utility in structured and predictable contexts, they often fall short in environments that are dynamic, unpredictable, and interdependent. In such complex environments, conditions change rapidly, tasks are often interlinked, and systems are required to integrate diverse components to operate effectively. These scenarios may also involve incomplete information and scalability challenges, requiring continuous adaptation and efficient coordination. As a result, the existing task allocation frameworks lead to suboptimal task assignments and inefficient use of resources.

Thus, in many embodiments, a task management device that is communicatively coupled to a plurality of AI agents over a communication network is provided to ensure seamless task assignment and execution by the plurality of AI agents. An AI agent may refer to an autonomous system or software entity configured to perform specific tasks or make decisions based on data, algorithms, and learned behavior. Further, the AI agent may include various components such as sensors for gathering data from the environment, actuators for interacting with the environment, and a perception system to process and interpret the sensory data. The AI agent may utilize decision-making and reasoning algorithms to choose optimal actions based on the current context. The AI agent may also include feature learning capabilities, allowing the AI agent to adapt and improve behavior over time. The AI agent may be utilized to execute various tasks such as data analysis, decision-making, automation, or interaction with users or other systems. The plurality of AI agents may belong to the same entity or be distributed across different entities, each responsible for specific roles or tasks within a broader system. The plurality of AI agents can operate independently or collaboratively, depending on a given task. The plurality of AI agents may collaborate and exchange information utilizing various communication protocols. In various embodiments, a task may include multiple subtasks. These subtasks can be handled by different AI agents working independently or collaboratively.

In yet various embodiments, to allocate a task effectively, the task management device may first determine one or more contextual features related to the task, such as a task type, specific requirements, and security conditions, which influence the decision-making process. Based on these determined contextual features, the task management device may identify a subset of AI agents that are best equipped to handle the task. The task management device then solicits task execution proposals from the identified subset of AI agents and evaluates the task execution proposals using various parameters such as execution time, cost, resource efficiency, and reputation scores.

After evaluating the task execution proposals, the task management device may select most appropriate AI agent(s) from the subset of AI agents based on their performance, expertise, and alignment with the task requirements. Once selected, the task or the subtasks are assigned to the selected AI agent(s). The selected AI agent(s) may execute the task or subtasks either independently or in parallel, depending on task complexity and requirements. The task management device may continuously monitor the progress of the assigned task, collecting task execution results, including completion status, time taken, resource utilization, and adherence to the task requirements. These task execution results may then be utilized to determine performance scores for each selected AI agent, based on which reputation scores of the selected AI agent(s) may be updated. The reputation scores may reflect past performance of the plurality of AI agents, and can be utilized to guide future task allocations, promoting continuous improvement and accountability.

The devices (e.g., the task management device) and methods discussed herein may address the above-recited challenges by providing a robust and optimized framework for task assignment, execution, and monitoring. In still more embodiments, the devices and methods discussed herein may leverage the contextual features such as the task type, the specific requirements, and the security requirements to assign tasks to the most suitable AI agent(s), ensuring that capability and availability of each AI agent align with the assigned task. This context-aware approach may reduce inefficiencies by ensuring that the task is only assigned to those AI agents best equipped to handle it.

In still further embodiments, the devices and methods discussed herein may support real-time monitoring of task execution, allowing for dynamic adjustments and providing timely insights into progress and performance. In still additional embodiments, the devices and methods discussed herein may be configured to be highly adaptable for environments with constantly changing demands or where task requirements evolve over time. Furthermore, by evaluating task execution proposals from multiple AI agents based on parameters such as execution time, cost, and resource efficiency, the devices and methods discussed herein ensure that the most efficient AI agents are selected, minimizing operational overhead and maximizing resource utilization.

In yet various embodiments, the devices and methods discussed herein may enhance reliability and accountability by incorporating reputation-based management. This approach enables the continuous updating of reputation scores of the AI agents based on their past task performance, ensuring that only high-performing AI agents are selected for future assignments. In yet more embodiments, the devices and methods discussed herein may support parallel task execution, allowing tasks or subtasks to be distributed across multiple AI agents, which further optimizes processing speed and resource utilization.

Aspects of the present disclosure may be embodied as an apparatus, a system, a method, or a computer program product. Accordingly, aspects of the present disclosure may take the form of an entirely hardware embodiment, an entirely software embodiment (including firmware, resident software, micro-code, or the like), or an embodiment combining software and hardware aspects that may all generally be referred to herein as a “function,” a “module,” an “apparatus,” or a “system.” Furthermore, aspects of the present disclosure may take the form of a computer program product embodied in one or more non-transitory computer-readable storage media storing computer-readable and/or executable program code. Many of the functional units described in this specification have been labeled as functions, to emphasize their implementation independence more particularly. For example, a function may be implemented as a hardware circuit comprising custom Very Large Scale Integration (VLSI) circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, a procedure, or a function. Nevertheless, the executables of an identified function need not be physically located together but may comprise disparate instructions stored in different locations which, when joined logically together, comprise the function and achieve the stated purpose for the function.

A function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, an apparatus, a processor, or a device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages, or the like) or other discrete electrical devices, in electrical communication with one or more other components through electrical lines of a Printed Circuit Board (PCB) or the like. Each of the functions and/or modules described herein, in many additional embodiments, may alternatively be embodied by or implemented as a component.

A circuit, as used herein, comprises a set of one or more electrical and/or electronic components providing one or more pathways for electric current. In still yet further embodiments, a circuit may include a return pathway for electric current, so that the circuit is a closed loop. In still yet additional embodiments, however, a set of components that does not include a return pathway for electric current may be referred to as a circuit (e.g., an open loop). For example, an integrated circuit may be referred to as a circuit regardless of whether the integrated circuit is coupled to ground (as a return pathway for electric current) or not. In several embodiments, a circuit may include a portion of an integrated circuit, an integrated circuit, a set of integrated circuits, a set of non-integrated electrical and/or electrical components with or without integrated circuit devices, or the like. In several more embodiments, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as a field programmable gate array, a programmable array logic, a programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a PCB or the like. Each of the functions and/or modules described herein, in numerous embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B, or C” or “A, B, and/or C” mean “any of the following: A; B; C; A and B; A and C; B and C; A, B, and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

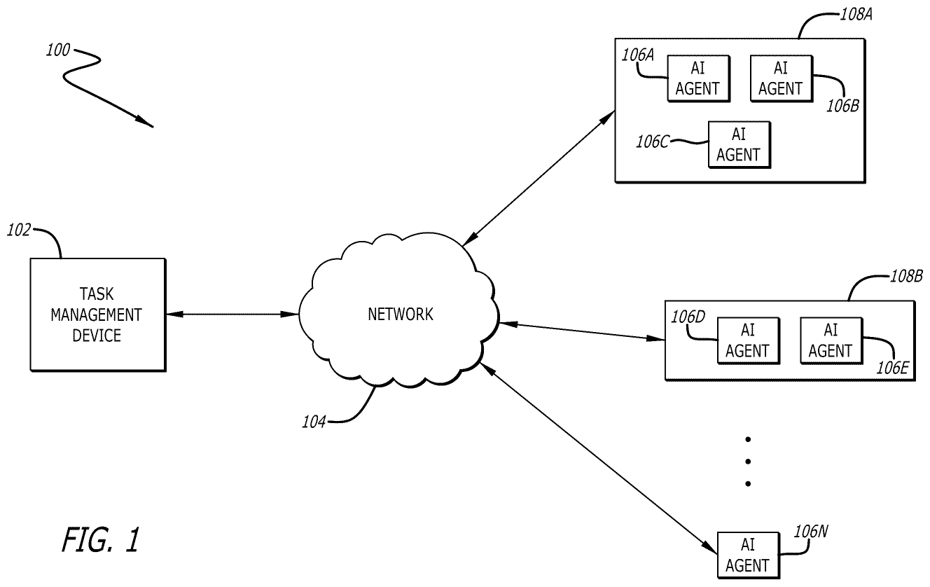

Referring to FIG. 1, a schematic diagram of a system 100 for context-aware task allocation and reputation management of Artificial Intelligence (AI) agents in accordance with various embodiments of the disclosure is shown. In a number of embodiments, the system 100 may be deployed within a distributed network architecture, where components such as hardware, software, and data are distributed across multiple geographical regions and interconnected devices or nodes. These components collaborate to perform functions, share resources, and provide services, while operating across a network.

In various embodiments, a task may refer to an operation that can be assigned to one or more AI agents for execution. The task may be intended to achieve a specific goal or outcome, which may involve processing, computation, or service delivery. In various examples, a task may be composed of multiple subtasks, each of which can be handled by different AI agents. Additionally, a task may be assigned to multiple AI agents, enabling parallel processing of the task. An example of a task may include a fraud detection operation, where transactional data is to be analyzed to identify fraudulent activities within a financial system. The task may include, but not limited to, four subtasks including a first subtask, a second subtask, a third subtask, and a fourth subtask. The first subtask may include identifying patterns in transactional data to detect anomalies that could indicate fraudulent behavior. The second subtask may include flagging transactions that exceed specific risk thresholds for further review. The third subtask may include analyzing flagged transactions to assess the likelihood of fraud. The fourth subtask may include reporting suspicious activities for further investigation by relevant authorities or teams. These four subtasks may collectively provide a comprehensive approach for detecting and addressing potential fraud. In further examples, a task may include upgrading Border Gateway Protocol (BGP) routing configurations across multiple data centers using Extended Range (XR) devices. In this example, the task requirements may include developing a comprehensive, optimized BGP configuration that aligns with network's global architecture and preparing BGP configuration for seamless deployment at a later date. In many further examples, a task can be to identify new vulnerabilities in a critical software system. Likewise, there can be many such examples of tasks that need to allocated.

In many embodiments, an AI agent may be a composite, autonomous software entity designed to perform specific tasks within a distributed network architecture. The AI agent may include multiple sub-agents, which may be developed by different entities or internal teams. These sub-agents may collaborate under control of a primary AI agent, enabling the AI agent to execute tasks more efficiently and effectively by leveraging the specialized capabilities of the sub-agents. The AI agent may operate based on a defined AI model that governs the AI agent's decision-making process, as well as a set of tools that allow the AI agent to interpret and execute tasks. The tools and the AI model work in conjunction to enable the AI agent to understand the nature of a given task, assess feasibility of the task, and perform the necessary actions. Further, the AI agent may include various components such as sensors for gathering data from the environment, actuators for interacting with the environment, and a perception system to process and interpret the sensory data. The AI agent may utilize decision-making and reasoning algorithms to choose optimal actions based on the current context. The AI agent may also include feature learning capabilities, allowing the AI agent to adapt and improve behavior over time. The distributed network architecture may facilitate the operation of multiple AI agents or sub-agents either independently or collaboratively across different systems, organizational units, and/or geographical locations.

In further embodiments, the system 100 may include a task management device 102, a network 104, and a plurality of AI agents 106A, 106B, 106C, 106D, 106E, . . . 106N (hereinafter, collectively referred to as the “plurality of AI agents 106A-N”). The task management device 102 and the plurality of AI agents 106A-N may be communicatively coupled to the network 104, which facilitates communication between the task management device 102 and the plurality of AI agents 106A-N. As shown in the non-limiting example of FIG. 1, three AI agents 106A, 106B, 106C are deployed within a cluster 108A, while two AI agents 106D, 106E are deployed within a cluster 108B. Each of the clusters 108A and 108B may be associated with a specific organization or team. For example, the cluster 108A may correspond to Company A, while the cluster 108B may correspond to Company B. In some embodiments, the AI agent 106A and the AI agent 106B may be associated with Team A (e.g., a sales team), and the AI agent 106C may be associated with Team B (e.g., an R&D team). In some more embodiments, the cluster 108A and the cluster 108B may belong to the same organization but represent different teams, with the cluster 108A being associated with Team A and the cluster 108B with Team B.

In a variety of embodiments, the task management device 102 may be a system component that is responsible for allocating tasks to one or more of the plurality of AI agents 106A-N and monitoring the task execution. For example, the task management device 102 may include suitable logic, circuitry, interfaces, or code, executable by the circuitry, which are configured to allocate the tasks and monitor the task execution. The task management device 102 may be configured to receive incoming tasks and assign the tasks to the appropriate AI agents 106A-N based on predefined criteria, such as the nature of the task, AI agent capabilities, and/or current workload. In one or more embodiments, the task management device 102 may be implemented as a physical unit, such as a server, or as a virtualized component operating within a cloud infrastructure. The task management device 102 may include hardware components, including a processor, a memory, a storage, and network interfaces, enabling the task management device 102 to manage task assignment in real-time. The network interfaces may allow the task management device 102 to communicate with the plurality of AI agents 106A-N and other system components, thereby facilitating coordination and task execution. Additionally, the task management device 102 may include user interfaces or control panels that allow administrators to monitor task assignment (or allocation), track the performance of the plurality of AI agents 106A-N, and adjusts the settings as needed. In several embodiments, the task management device 102 may implement a task optimization logic, stored in the memory, to efficiently allocate and manage execution of tasks by one or more AI agents among the plurality of AI agents 106A-N within the system 100.

In many further embodiments, the network 104 may encompass a wide range of network types and communication infrastructures, including but not limited to, a Wireless Fidelity (Wi-Fi) network, a Light Fidelity (Li-Fi) network, a Local Area Network (LAN), a Wide Area Network (WAN), a Metropolitan Area Network (MAN), a satellite network, the Internet, a fiber optic network, a coaxial cable network, an Infrared (IR) network, a Radio Frequency (RF) network, and a combination thereof. The network 104 may provide the necessary communication infrastructure for the various components of the system 100, such as the task management device 102 and the plurality of AI agents 106A-N, to exchange data and coordinate tasks effectively.

In additional embodiments, the network 104 may support both wired and wireless communication protocols, depending on the specific configuration and operational needs of the system 100. For example, wired communication protocols may include Ethernet over LAN or fiber optic connections, while wireless communication may be facilitated through protocols like Wi-Fi, LTE, or other wireless communication standards. The system 100 can also leverage various communication protocols, including but not limited to, Transmission Control Protocol and Internet Protocol (TCP/IP), User Datagram Protocol (UDP), Long Term Evolution (LTE) communication protocols, Application Programming Interface (API) protocols, or any combination of these or other suitable protocols. This flexibility in the network 104 and communication protocols may allow for seamless integration and operation of the system 100 across diverse network environments, enabling efficient and reliable task coordination and execution across geographically distributed devices and agents.

In a non-limiting example, various operations of the task management device 102 and the plurality of AI agents 106A-N are described with respect to an incoming task received by the task management device 102. In an example, the task may include a plurality of subtasks that need to be executed in sequence or parallel. In further examples, the task can be a standalone task, requiring a single action or process. Upon receiving the incoming task, the task management device 102 may be configured to determine one or more contextual features associated with the task. The one or more contextual features may refer to specific characteristics or attributes related to the task that influence how the task should be allocated, executed, or managed. The one or more contextual features may include, but are not limited to, a task type, one or more task specific requirements, and one or more security requirements. The task type may refer to a category or nature of the task, which influences the type of processing or actions required to complete the task. Examples of task types may include, but are not limited to, data processing, decision-making, data analysis, service delivery, or the like. The task type may influence AI agent selection, ensuring that the task is handled by the most suitable AI agents. For example, if the task type is image recognition, an AI agent equipped with computer vision capabilities may be required, while a network management task may require an AI agent skilled in handling different network configurations and protocols.

Further, the one or more task specific requirements may refer to conditions or parameters that must be met for successful task execution. Examples of task specific requirements may include, but are not limited to, resource constraints (e.g., processing power and memory), time constraints (e.g., deadlines or urgency), data input/output constraints, skill requirements (e.g., specific expertise, knowledge, or tool needed to complete the task), or infrastructure constraints (e.g., cloud or on-premise systems). These task specific requirements may ensure that the task is performed under desired parameters, often guiding AI agent selection based on their capabilities and the resources required for task completion. For example, if a task requires large-scale data analysis, an AI agent with high-performance computational resources may be required.

Furthermore, the one or more security requirements may refer to conditions and protocols that must be followed to ensure confidentiality, integrity, and protection of data and systems involved in executing the task. Examples of security requirements may include, but are not limited to, confidentiality and encryption. The security requirements may further involve authentication and authorization processes, encryption standards, or compliance with regulatory standards. The security requirements may guide in AI agent selection. For example, if the task involves handling sensitive data, an AI agent capable of implementing necessary security protocols, such as secure data transmission or encryption, may be required.

In many additional embodiments, based on the determined one or more contextual features, the task management device 102 may be configured to identify a subset of AI agents from the plurality of AI agents 106A-N. To identify the subset of AI agents, the task management device 102 may be configured to evaluate the competency of each of the plurality of AI agents 106A-N relative to the task context (e.g., the determined one or more contextual features) and identify the appropriate subset of AI agents that align with the determined one or more contextual features. Such identification may involve evaluating various contextual factors such as each AI agent's current workload, available resources (e.g., processing power, memory), expertise in relation to the specific, and security requirements of the task.

In an example embodiment, the task management device 102 may reference a database (e.g., a local database or a cloud database) that stores information about the plurality of AI agents 106A-N to facilitate the identification of the subset of AI agents. The database may include metadata about each AI agent of the plurality of AI agents 106A-N, such as capabilities, resource requirements, performance metrics, compatibility constraints, and specific security certifications. By leveraging this information, the task management device 102 can determine which AI agents among the plurality of AI agents 106A-N align with (e.g., meet or satisfy) the one or more contextual features of the task. For example, in context of a financial transaction management scenario, the task management device 102 may determine that the one or more contextual features of a task involve processing a high-value transaction with stringent compliance requirements. In such a scenario, the task management device 102 may identify those AI agents among the plurality of AI agents 106A-N that have advanced fraud detection algorithms and hold certifications such as Payment Card Industry Data Security Standard compliance. Further, in context of a network management scenario, the one or more contextual features may specify that the task involves mitigating a potential Distributed Denial of Service (DDoS) attack. In such a scenario, the task management device 102 may identify those AI agents among the plurality of AI agents 106A-N equipped with real-time traffic analysis and intrusion prevention capabilities. Additionally, if the task specifies high-security constraints due to the sensitivity of network data, the task management device 102 may identify those AI agents among the plurality of AI agents 106A-N with strong encryption protocols and certifications such as ISO/IEC 27001. Thus, the identification process may ensure that only those AI agents among the plurality of AI agents 106A-N whose capabilities and operational conditions best align with the task's contextual features (e.g., demands) are identified, thereby optimizing task execution potential and resource efficiency. In a non-limiting example, it is assumed that the subset of AI agents includes the AI agents 106A, 106B, 106D. Hereinafter, the subset of AI agents is referred to as the “subset of AI agents 106A, 106B, 106D”

In many further embodiments, the task management device 102 may be configured to transmit a query to the identified subset of AI agents 106A, 106B, 106D to request a set of task execution proposals for performing the task or its subtasks. In response to this query, the identified subset of AI agents 106A, 106B, 106D may submit their respective task execution proposals to the task management device 102. A task execution proposal may refer to a bid submitted by an AI agent (e.g., any of the identified subset of AI agents 106A, 106B, 106D), outlining a proposed strategy for completing the task. The task execution proposal may include details such as the proposed methodology for task execution, required resources (e.g., hardware and software), expected completion time, potential risks, and estimated costs associated with task completion.

In still further embodiments, the task management device 102 may obtain the set of task execution proposals in response to the query transmitted to the subset of AI agents 106A, 106B, 106D. The task management device 102 may be further configured to evaluate the obtained task execution proposals based on one or more evaluation parameters. The one or more evaluation parameters may include, but are not limited to, task execution time, task execution cost, resource efficiency, and reputation score. Task execution time may refer to the total duration required to complete a task or subtask, from initiation to completion. Task execution cost may refer to the total cost (e.g., monetary cost, computational cost, energy cost, risk exposure, or the like) incurred during the execution of a task or subtask. Resource efficiency may reflect the optimal utilization of resources, such as memory, processing power, and network bandwidth, necessary for performing a task or subtask. Reputation score may refer to a numerical value or rating that represents an AI agent's past performance, derived from historical task executions. The reputation score may be determined by evaluating factors such as task completion accuracy, timeliness, resource usage, and adherence to specified requirements. A higher reputation score may indicate a more consistent history of successful task completion, signifying greater reliability and confidence in the AI agent's ability to meet performance standards and requirements for future task assignments. By evaluating these parameters, the task management device 102 may ensure that the task is allocated to the suitable AI agent(s) among the plurality of AI agents 106A-N, based on a comprehensive of the task execution proposals.

In yet several embodiments, when a task is suitable for parallel execution, the task management device 102 may assign the entire task to multiple AI agents (e.g., two or more of the subset of AI agents 106A, 106B, 106D) simultaneously. For instance, the task may involve processing large datasets or performing complex computations that can be divided into independent execution paths. In such cases, the multiple AI agents may execute the task concurrently, while the task management device 102 monitors the execution in real-time or near real time. In yet more embodiments, when the task includes a plurality of subtasks, the task management device 102 may assign each subtask to a different AI agent (e.g., any of the subset of AI agents 106A, 106B, 106D). For example, in a fraud detection operation, the task may include four distinct subtasks. The first subtask involves identifying patterns in transactional data to detect anomalies indicative of fraudulent behavior. The second subtask includes flagging transactions that exceed specific risk thresholds for further review. The third subtask involves analyzing flagged transactions to assess the likelihood of fraud. The fourth subtask includes reporting suspicious activities for further investigation by relevant authorities or teams. In this scenario, each subtask can be assigned to a different AI agent (e.g., any of the subset of AI agents 106A, 106B, 106D), with the task management device 102 ensuring that each AI agent is suitably capable of executing its respective subtask. Each AI agent can independently execute the assigned subtask.

In many more embodiments, based on the evaluation of the task execution proposals, the task management device 102 may select one or more AI agents from the identified subset of AI agents 106A, 106B, 106D for task assignment. In scenarios involving parallel task execution, the task management device 102 may assign the entire task to selected multiple AI agents (e.g., two or more of the subset of AI agents 106A, 106B, 106D) simultaneously. Conversely, when the task includes subtasks, the task management device 102 may assign each subtask to a different AI agent from the selected one or more AI agents. This assignment ensures that the task is executed in the most efficient manner, leveraging the capabilities and availability of the selected one or more AI agents. In a non-limiting example, it is assumed that the one or more AI agents selected for the task assignment include the AI agents 106A, 106B.

During execution, the task management device 102 may monitor the progress of the assigned task. Each AI agent 106A, 106B may report the result of its respective task execution (referred to as a task execution result), whether for a subtask or the entire task, back to the task management device 102. A task execution result may refer to the outcome or report provided by an AI agent after completing a task or subtask assigned to it. The task execution result may include various metrics that reflect how the task was performed, including but not limited to, a completion status (success or failure), actual time taken to complete the task, resource utilization, and adherence to any predefined task requirements or performance criteria. The task execution result may serve as the basis for evaluating the AI agent's performance and can be used to calculate a performance score that reflects the efficiency, accuracy, and effectiveness of the AI agent in completing the task.

In yet various embodiments, the task management device 102 may then evaluate the task execution results and determine a performance score for each AI agent 106A, 106B based on one or more determination parameters. A performance score may refer to a numerical value or rating that quantifies the effectiveness and efficiency with which an AI agent performs a given task or subtask. In examples, the one or more determination parameters may include, but are not limited to, an actual task execution time and an actual resource efficiency. The actual task execution time may refer to the time taken by an AI agent to complete a task or subtask, from initiation to completion. The actual resource efficiency may refer to the utilization of resources, such as memory, processing power, storage, and network bandwidth, by an AI agent during task or subtask execution. Based on the performance scores, the task management device 102 may update the reputation score of each selected AI agent 106A, 106B, facilitating continuous improvement and accountability within the system 100. For example, once the performance score is determined, the task management device 102 may compare the performance score with a benchmark threshold or one or more historical performance records. If the determined performance score exceeds the benchmark threshold or expectations as per the historical performance records, the task management device 102 may increase the reputation score of the AI agent proportionally. Conversely, if the performance score falls short, the task management device 102 may reduce the reputation score. In further examples, the task management device 102 may apply an exponential decay to ensure that most recent performance score impacts the reputation score more significantly than older performance scores, keeping the reputation score reflective of current capabilities. The updated reputation scores may be stored in a storage device for future reference and decision-making.

In several more embodiments, the task management device 102 may be configured to perform one or more interactions with the plurality of AI agents 106A-N utilizing a smart contract. The one or more interactions may include at least one of a first interaction to obtain a task execution proposal of the set of task execution proposals, a second interaction to assign the received task, a third interaction to monitor the execution of the assigned task, or a fourth interaction to receive the task execution result. In an embodiment, the smart contract may include one or more terms and conditions associated with the task.

In an example embodiment, a smart contract may correspond to a self-executing digital contract with conditions and rules that govern the interactions between the task management device 102 and the plurality of AI agents 106A-N. The smart contract may be deployed on a blockchain or decentralized network, ensuring that the terms and conditions associated with the task are secure, transparent, and tamper-proof. Further, the smart contract may include a set of instructions, for example, in a programming language or another relevant blockchain language. These instructions may define the terms and conditions for various interactions between the task management device 102 and the plurality of AI agents 106A-N. For example, the smart contract may specify the conditions under which an AI agent can submit a task execution proposal, detailing how task execution proposals are to be evaluated, accepted, or rejected. The smart contract can also include the rules for assigning tasks, ensuring that once a task is assigned to an AI agent, the task is carried out according to the terms and conditions set forth in the smart contract. Furthermore, the smart contract may include conditions for monitoring, evaluating, and rewarding task execution, such as tracking the progress of the task in real-time, checking if the task is completed within the specified time frame, ensuring that the task adheres to the agreed-upon parameters, or the like. In other words, the smart contract may provide a mechanism for automating and securing the task management process, allowing for trustless interactions where the terms and conditions are clear, the execution is transparent, and the outcomes are verifiable without relying on a central authority.

In several additional embodiments, the system 100 for context-aware task allocation and reputation management of the plurality of AI agents 106A-N may offer an efficient and flexible framework for managing complex tasks in distributed environments. By considering contextual features, task execution proposals, and evaluation parameters such as task execution time, resource efficiency, and reputation scores, the system 100 may ensure optimal task assignment and execution. The ability to assign tasks in parallel or distribute them across the plurality of AI agents 106A-N enhances resource utilization and operational efficiency. Furthermore, the continuous monitoring of task progress and the updating of AI agents' reputation scores support performance improvement and foster accountability within the system 100.

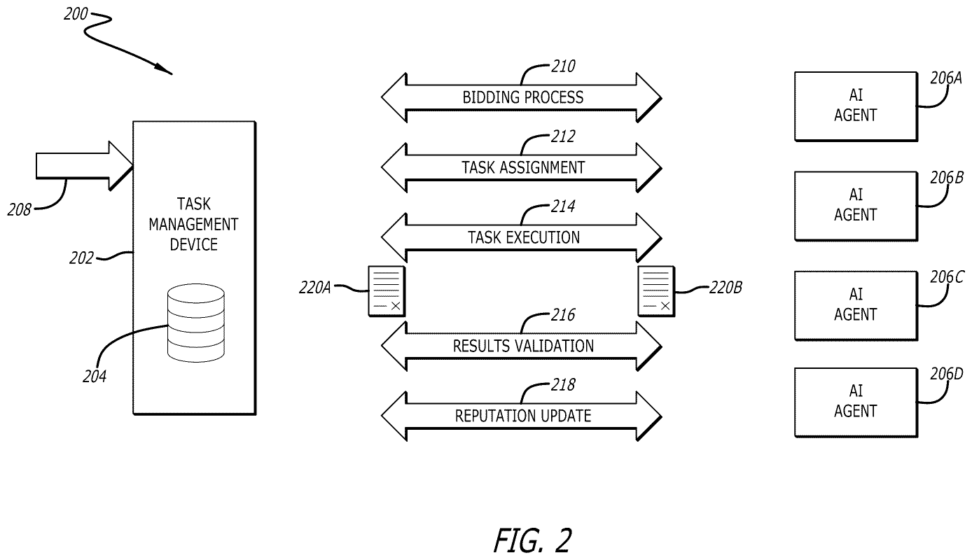

Although a specific embodiment for the system for context-aware task allocation and reputation management of the AI agents suitable for carrying out the various steps, processes, methods, and operations described herein is discussed with respect to FIG. 1, any of a variety of systems and/or processes may be utilized in accordance with embodiments of the disclosure. For example, the task management device 102 may be implemented within or integrated into another device or system. In such scenarios, the task optimization logic may be embedded within the memory and processor of a primary device, such as a server, cloud-based infrastructure, or network node. As a result, the task management device 102 may be responsible for managing tasks within the system 100 without requiring a separate, standalone device. Instead, the task optimization logic operates in conjunction with other system components, leveraging the resources and capabilities of the primary device to optimize task execution and management. The elements depicted in FIG. 1 may also be interchangeable with other elements of FIGS. 2-13 as required to realize a particularly desired embodiment.

Referring to FIG. 2, a detailed schematic diagram of a system 200 for context-aware task allocation and reputation management of AI agents, illustrating interactions between various components of the system 200 in accordance with various embodiments of the disclosure is shown.

In many embodiments, the system 200 may include a task management device 202, a database 204, and a plurality of AI agents, including a first AI agent 206A, a second AI agent 206B, a third AI agent 206C, and a fourth AI agent 206D (collectively referred to as the “plurality of AI agents 206A-D” or the “AI agents 206A-D”). The system 200 may serve as an adaptive, context-aware, and reputation-based task management system for the plurality of AI agents 206A-D deployed in a distributed network architecture. In a number of embodiments, the system 200 may be equivalent to the system 100 of FIG. 1, where the task management device 202 corresponds to the task management device 102. The plurality of AI agents 206A-D may represent any of the plurality of AI agents 106A-N shown in FIG. 1. In more embodiments, the plurality of AI agents 206A-D may be associated with different organizations and teams. In some more embodiments, the plurality of AI agents 206A-D may be associated with different teams within the same organization. In yet more embodiments, the plurality of AI agents 206A-D may belong to the same team within an organization. Although four AI agents 206A-D are depicted in FIG. 2, it will be understood by a person skilled in the art that the system 200 can be configured to be scalable and capable of supporting a variable number of AI agents, including fewer than four or more than four, depending on the specific requirements of a task(s) to be assigned and the operational configuration of the system 200. The system 200 can be designed to accommodate any number of AI agents, and the actual number AI agents that are deployed can be dynamically adjusted based on the complexity and scope of the task(s) to be executed.

In several embodiments, the task management device 202 may be configured to optimize assignment and execution of tasks among the plurality of AI agents 206A-D in a distributed network architecture. The task management device 202 may utilize advanced context interpretation, dynamic bidding, and adaptive learning mechanisms to ensure efficient and effective task management. In various embodiments, the database 204 may serve as a repository for storing relevant information, such as task execution results, AI agent performance data, reputation scores, and other records necessary for optimizing task assignment and evaluation within the system 200. In still more embodiments, although the database 204 is shown to be implemented within the task management device 202, the database 204 may alternatively be located externally. The database 204 may reside on a separate server or be part of a cloud-based infrastructure, accessible over a network. In such embodiments, the task management device 202 may communicate with the database 204 to store and retrieve relevant data, such as task execution results, AI agent performance data, and reputation scores.

In still yet more embodiments, the task management device 202 may receive a task 208 from an external source. Examples of the external source may include, but are not limited to, an external system, a user input, an external Application Programming Interface (API), or a web service. In yet various embodiments, the task management device 202 may create the task 208 locally, rather than receiving the task 208 from the external source. For example, the task management device 202 may generate the task 208 in response to specific events or triggers, such as arrival of new data, completion of a prior task, or detection of an issue within the system 200.

In a variety of embodiments, upon receiving or generating the task 208, the task management device 202 may initiate a bidding process 210 to facilitate an efficient execution of the task 208. The bidding process 210 may allow the AI agents 206A-D to propose their strategies for executing the task 208, enabling the task management device 202 to evaluate the most optimal execution approach. In numerous embodiments, the bidding process 210 may involve several stages (for example, Stage 1-5) to ensure that the task 208 is allocated to suitable AI agent(s) 206A-D.

In Stage 1, the task management device 202 may determine one or more contextual features associated with the received task 208. These contextual features may refer to distinct attributes or conditions related to the task 208, such as task type, specific requirements, and requirements and security requirements. In additional embodiments, the task management device 202 may leverage Natural Language Processing (NLP) techniques or other suitable information extraction mechanisms to analyze and interpret task descriptions, extracting the relevant contextual features. For example, if the task 208 is provided as a natural language input, such as a text document, an email, or a spoken command, the task management device 202 may process the input to identify key components of the task 208, including task type, resource constraints (e.g., memory, processing power), time constraints (e.g., deadlines, urgency), and security protocols (e.g., encryption, confidentiality). The extracted contextual features may provide the task management device 202 with a comprehensive understanding of the characteristics and requirements of the task 208, which may guide the subsequent task allocation and execution process.

In Stage 2, based on the determined one or more contextual features, the task management device 202 may identify a subset of AI agents from the plurality of AI agents 206A-D. The task management device 202 may evaluate and filter the plurality of AI agents 206A-D by assessing their respective operational context and current availability in relation to the contextual features of the received task 208. In many additional embodiments, the task management device 202 may select those AI agents from the plurality of AI agents 206A-D whose situational context aligns best with the requirements of the task 208. Additionally, the task management device 202 may assess availability of each of the plurality of AI agents 206A-D to ensure that the identified subset of AI agents can begin task execution in a timely manner, considering their current workload and resource capacity. In further embodiments, the task management device 202 may systematically evaluate the suitability of each of the plurality of AI agents 206A-D based on how well their capabilities align with the contextual features associated with the task 208. This evaluation may include factors such as AI agent's historical performance, task execution patterns, and any specific task requirements identified in Stage 1. For example, the task management device 202 may identify the first AI agent 206A, the third AI agent 206C, and the fourth AI agent 206D from the plurality of agents 206A-D (hereinafter, collectively referred to as the “subset of AI agents 206A, 206C, 206D”), as these AI agents align well with the determined contextual features associated with the task 208.

In Stage 3, once the subset of AI agents 206A, 206C, 206D has been identified, the task management device 202 may transmit a query to the identified subset of AI agents 206A, 206C, 206D, requesting for submission of a set of task execution proposals. A task execution proposal may represent a bid from an AI agent, in which the AI agent outlines its proposed strategy for executing a task. The task execution proposal may include the AI agent's approach to fulfilling the task, such as the execution method, expected duration, reputation score, required computational resources, and any associated costs. In response to this query, the identified subset of AI agents 206A, 206C, 206D may submit their respective task execution proposals to the task management device 202. For example, the first AI agent 206A may submit task execution proposal A, the third AI agent 206C may submit task execution proposal C, and the fourth AI agent 206D may submit task execution proposal D.

In Stage 4, the task management device 202 may obtain the set of task execution proposals as response(s) to the transmitted query from the subset of AI agents 206A, 206C, 206D. In still additional embodiments, the set of task execution proposals may include performance guarantees or additional context regarding the AI agent's ability to meet specific task requirements, such as deadlines, precision, or compliance with security protocols. For example, the task management device 202 may obtain the task execution proposal A from the first AI agent 206A, which specifies that the task 208 will take 3 hours to complete. The task execution proposal A may further include a reputation score of 85 out of 100, indicating that the first AI agent 206A has a reliable track record for completing tasks on time with good accuracy. In further examples, the task management device 202 may obtain the task execution proposal C from the third AI agent 206C, which proposes that the task 208 will take 5 hours to complete. The task execution proposal C may further include a reputation score of 75 out of 100, reflecting that the third AI agent 206C caused occasional delays in task execution has consistent performance in terms of task accuracy and security compliance. Further, the task management device 202 may obtain the task execution proposal D from the fourth AI agent 206D, which suggests completing the task 208 in 4 hours. The task execution proposal D includes a reputation score of 90 out of 100, highlighting the fourth AI agent 206D has strong ability to meet deadlines, deliver high-quality results, and optimize resource usage.

In Stage 5, the task management device 202 may evaluate the obtained set of task execution proposals against one or more evaluation parameters. The one or more evaluation parameters may include at least one of a task execution time, a task execution cost, a resource efficiency, or a reputation score. The task execution time may refer to the total duration required to complete a task or subtask, from initiation to completion. The task execution cost may refer to the total cost incurred during the execution of a task or subtask. The resource efficiency may reflect to the optimal utilization of resources, such as memory, processing power, and network bandwidth, necessary for performing a task or subtask. The reputation score may refer to a numerical value or rating that represents an AI agent's past performance, derived from historical task executions. In numerous embodiments, the task management device 202 may evaluate the task execution proposal A, the task execution proposal C, and the task execution proposal D, considering their respective execution times and reputation scores, to determine which task execution proposal(s) is most suitable based on the specific needs of the task 208, such as urgency and reliability. This evaluation process may enable the task management device 202 to compare the task execution proposals and select the most suitable task execution proposal(s), ensuring that the task 208 is completed efficiently and effectively.

In one or more embodiments, the Stages 1-5 of the dynamic bidding process 210 offer flexibility and adaptability, enabling the task management device 202 to assign the task 208 efficiently in response to changing contextual conditions and the specific capabilities of the plurality of AI agents 206A-D. The bidding process 210 may further allow each of the identified subset of AI agents 206A, 206C, 206D to submit a tailored bid that reflects its capabilities, available resources, and alignment with the specific requirements of the task 208.

In yet further embodiments, after the bidding process 210, the task management device 202 may initiate a task assignment process 212. During the task assignment process 212, the task management device 202 may select at least one AI agent from the subset of AI agents 206A, 206C, 206D based on the evaluation of the set of task execution proposals. The task management device 202 may then assign the task 208 to the selected at least one AI agent. For example, if the task 208 has high urgency, the task management device 202 may select the first AI agent 206A, as the task execution proposal A specifies the shortest task execution time of 3 hours. Given the importance of reliability, the task management device 202 may select the fourth AI agent 206D, as the task execution proposal D represents the highest reputation score of 90, indicating superior consistency and quality of the fourth AI agent 206D in past task executions. If the task 208 requires a balance between execution time and reliability, the task management device 202 may select the first AI agent 206A if the deadline is tight and urgency is a key factor. However, if the task 208 allows for a slightly longer duration for more reliable execution, the task management device 202 may select the fourth AI agent 206D.

Thus, the task management device 202 may ensure that task 208 is assigned to that AI agent(s) among the subset of AI agents 206A, 206C, 206D whose capabilities and current operational state best align with the specific requirements of the task 208. By assigning the task 208 to the most suitable AI agent(s), the task management device 202 may enhance the accuracy and efficiency of the overall task execution process. Ensuring that the task 208 is handled by the AI agent(s) with the necessary expertise, resources, and contextual alignment ensures that the task 208 is executed in a manner that is consistent with its intrinsic characteristics and operational requirements. This, in turn, optimizes the effectiveness of the system 200 and improves overall task throughput and quality. In a non-limiting example, it is assumed that the selected at least one AI agent includes the first AI agent 206A. However, in other examples, multiples AI agents can also be selected for task execution, at sub-task level or for parallel execution.

In numerous additional embodiments, after the task assignment process 212, the task management device 202 may initiate a task execution process 214. During the task execution process 214, the task management device 202 may monitor the execution of the assigned task 208 by the selected at least one AI agent, for example, the first AI agent 206A. The task management device 202 may track the task execution progress in real time. The task management device 202 may also receive a task execution result from the selected at least one AI agent (for example, the first AI agent 206A) based on the execution of the assigned task 208. The task execution result may refer to the outcome or report provided by the selected at least one AI agent upon completing the task 208. The task execution result may include various metrics that reflect how the task 208 was performed, such as a completion status (success or failure), an actual time taken to complete the task 208, resource utilization, and adherence to any predefined task requirements or performance criteria. The task execution result serves as the basis for evaluating the performance of the selected at least one AI agent and can be used to determine a performance score, reflecting the efficiency, accuracy, and effectiveness of the selected at least one AI agent in completing the task 208.

In still numerous embodiments, after the task execution process 214, the task management device 202 may initiate a result validation process 216. During the result validation process 216, the task management device 202 may validate the task execution result against one or more validation parameters to ensure that the task 208 meets the required standards. The one or more validation parameters may include one or more of compliance with one or more task requirements of the task 208 or a task execution accuracy. The task management device 202 may assess whether the task execution result satisfies all specified conditions, such as deadlines, quality standards, resource usage, and any other performance criteria. For example, the task management device 202 may check whether the task 208 was completed within the expected time frame, whether the resource utilization remained within acceptable limits, and whether the task 208 was carried out with the required level of precision or reliability. Additionally, the task management device 202 may verify the accuracy of the task execution by comparing the task execution result against predefined expected outcomes or performance benchmarks. If the task execution result fails to meet one or more validation parameters, the task management device 202 may trigger a corrective action or further review process.

In yet numerous embodiments, after the result validation process 216, the task management device 202 may initiate a reputation update process 218. During the reputation update process 218, the task management device 202 may determine a performance score for the selected at least one AI agent (for example, the first AI agent 206A) based on the received task execution result and one or more determination parameters. These determination parameters may include, but are not limited to, an actual task execution time and an actual resource efficiency. In some embodiments, the performance score for the selected at least one AI agent is further determined based on the validation of the task execution result.

Subsequently, the task management device 202 may update the reputation score of the selected at least one AI agent (for example, the first AI agent 206A) based on the determined performance score. The continuous tracking and updating of reputation score of the selected at least one AI agent based on the performance in previous tasks ensures that the task 208 is assigned to reliable and capable AI agent(s). The task management device 202 may be further configured to store the updated reputation score of the selected at least one AI agent in a distributed ledger. In examples, the distributed ledger may be a blockchain-based database, such as the database 204. Integrating the distributed ledger for storing the updated reputation score provides an added layer of security, transparency, and trust, making the system 200 more robust and tamper-proof. This approach ensures that the updated reputation score remains secure and accessible to all users, fostering trust throughout the system 200. Additionally, the task management device 202 may be configured to provide feedback to the selected at least one AI agent (for example, the first AI agent 206A) regarding the execution of the task 208. The feedback may include at least one of the performance score or the updated reputation score. The provision of feedback enhances the system's 200 adaptability and efficiency, driving continuous improvement in task execution and AI agent performance.

For example, if the selected first AI agent 206A completes the task 208 in 3 hours, which is slightly above the required execution time of 2 hours, the task management device 202 may determine the performance score of the AI agent 206A as 90 out of 100. This performance score may reflect the first AI agent's 206A timely completion, optimal resource usage, and high-quality execution. In contrast, if the fourth AI agent 206D were selected and completes the task 208 in 4 hours but meets the required quality standards, the task management device 202 may determine a performance score of 70 out of 100 for the fourth AI agent 206D. The task management device 202 may then update the reputation score of the first AI agent 206A, increasing it from 85 to 88 to reflect improved reliability. Further, the task management device 202 may update the reputation score of the fourth AI agent 206D, decreasing it from 90 to 88, underscoring the importance of meeting deadlines and maintaining efficiency. These ongoing updates to performance and reputation scores enable the system 200 to make informed decisions in future task assignments, ensuring that tasks are allocated to the most reliable and efficient AI agents.

In still various embodiments, the task management device 202 is further configured to perform one or more interactions with the plurality of AI agents 206A-D including the selected at least one AI agent utilizing a plurality of smart contracts including smart contracts 220A and 220B, to manage task execution. The one or more interactions may include at least one of a first interaction to obtain a task execution proposal of the set of task execution proposals, a second interaction to assign the received task 208, a third interaction to monitor the execution of the assigned task 208, or a fourth interaction to receive the task execution result. Each of the smart contracts 220A and 220B may include one or more terms and conditions associated with the task 208. This ensures that the task 208 is executed securely, transparently, and with minimal manual oversight, thereby enhancing the overall efficiency and reliability of the system 200. By managing task execution and agent interactions through the smart contracts 220A and 220B, the system 200 may provide a secure, automated, and decentralized approach, which reduces manual oversight and minimizes the risk of disputes.

In yet numerous embodiments, the above description primarily focuses on assigning the task 208 as a whole to a single AI agent 206A. However, in some scenarios, the task 208 may be assigned to multiple AI agents among the identified subset of AI agents 206A, 206C, 206D for parallel execution. For example, the task management device 202 may select two or more AI agents from the subset of AI agents 206A, 206C, 206D, such as the first AI agent 206A and the fourth AI agent 206D, based on the evaluation of the task execution proposals. The task management device 202 may then assign the task 208 to the two or more AI agents (e.g., the first AI agent 206A and the fourth AI agent 206D) for parallel execution. Furthermore, the task management device 202 may monitor an execution of the task 208 by each of the two or more AI agents. The task management device 202 may receive a plurality of task execution results from the two or more AI agents based on the execution of the task 208. The task management device 202 may then compare the plurality of task execution results and generate a final task execution result based on the comparison. Additionally, the task management device 202 may be configured to determine a performance score for each of the two or more AI agents based on the final task execution result and one or more determination parameters. The task management device 202 may then update a reputation score of each of the two or more AI agents based on the determined performance score. This parallel execution model enables the system 200 to handle larger or more complex tasks that may require multiple AI agents working concurrently, thereby optimizing system resources and improving overall throughput.

In an example scenario where a government agency seeks to identify potential vulnerabilities in a critical software system, the system 200 may coordinate the independent analyses of multiple AI agents, each representing a different entity (such as a government agency, a military contractor, and a large information technology “IT” company) with specialized expertise. These AI agents operate independently, ensuring diverse perspectives and comprehensive identification of security vulnerabilities. According to an implementation, the task management device 202 may dynamically allocate specific roles to each AI agent based on their contextual capabilities, ensuring that the analysis is thorough, accurate, and focused on identifying critical vulnerabilities. The task management device 202 may facilitate efficient execution through the bidding process 210, the task assignment process 212, the task execution process 214, the result validation process 216, and the reputation update process 218. This framework may support the identification of high-priority vulnerabilities, contributing to enhanced system security.

In this example, the multiple AI agents may include an AI agent A, an AI agent B, and an AI agent C. The AI agent A may represent a government cybersecurity agency known for its expertise in national security and critical infrastructure protection. The AI agent B may represent a military contractor with deep experience in secure software analysis and defense systems. The AI agent C may represent a large IT company with extensive resources and advanced tools for software vulnerability detection.

Continuing the above example, the government agency may send a high-priority task to the task management device 202, requesting the identification of vulnerabilities in a critical software system. The task requires independent analyses from each of the AI agents, focusing on identifying vulnerabilities that could potentially be exploited by malicious actors. The task management device 202 evaluates the task and recognizes the need for specialized knowledge in cybersecurity, defense systems, and large-scale software analysis. Subsequently, the task management device 202 may distribute the task to the identified AI agents, including the AI agent A, the AI agent B, and the AI agent C.

Each AI agent may conduct its own independent analysis of the software system. For example, the AI agent A conducts a thorough analysis leveraging its national security expertise, focusing on vulnerabilities that could be exploited in a cyberattack targeting critical infrastructure. The AI agent B performs an independent analysis, applying advanced techniques tailored to defense systems, uncovering potential security flaws with a focus on military applications. The AI agent C utilizes its vast resources and cutting-edge tools to conduct a comprehensive scan of the software, identifying possible weaknesses and security gaps, emphasizing a broad, enterprise-level security perspective. After completing their analyses, each AI agent submits a detailed report (result) of the vulnerabilities they identified. These reports include the nature of the vulnerabilities, potential risks, and suggested mitigations.

The task management device 202 may compare the results from the three AI agents, assessing the accuracy, thoroughness, and reliability of each report. The task management device 202 may identify overlaps in findings, unique vulnerabilities identified by specific AI agents, and any discrepancies between the reports. Based on the evaluation, the task management device 202 ensures a comprehensive and well-rounded understanding of the system's security posture. The task management device 202 may then update the reputation of each AI agent. The AI agent A may receive a high reputation boost if it identifies critical vulnerabilities missed by other agents, particularly those related to national security. The AI agent B is evaluated based on the depth and relevance of its analysis, especially in the context of defense and military applications, and may receive a reputation update for its precision in identifying vulnerabilities relevant to these areas. The AI agent C is assessed on the comprehensiveness of its scan, the accuracy of its findings, and its ability to detect vulnerabilities across a broad spectrum of potential threats.

The above example demonstrates the ability of the task management device 202 to coordinate independent, specialized analyses by multiple AI agents. By assigning the same task to different AI agents and later comparing their task execution results, the system 200 ensures that the identified vulnerabilities are both comprehensive and robust. The role of the task management device 202 in evaluating and updating the reputation of each AI agent may guarantee that future tasks are assigned to the most reliable and effective AI agents, ensuring a higher level of security for subsequent operations. This approach highlights the flexibility and reliability of the system 200 in high-stakes environments where independent assessments and diverse perspectives are critical for ensuring the security of vital software systems. The ongoing evaluation and reputation update process ensures that the task management device 202 continuously optimizes the selection and performance of AI agents for future security tasks.

In further scenarios, the task 208 may include a plurality of subtasks, where each subtask can be assigned to a different AI agent among the identified subset of AI agents 206A, 206C, 206D. According to an implementation, the task management device 202 may select a corresponding AI agent, from the subset of AI agents 206A, 206C, 206D, for each subtask of the plurality of subtasks based on the evaluation of the set of task execution proposals. In an implementation, the task management device 202 may assign each subtask to the selected corresponding AI agent. For example, if the task 208 includes two subtasks, such as a data processing subtask and a data analysis subtask, the task management device 202 may assign the data processing subtask to one AI agent (for example, the first AI agent 206A), and the data analysis subtask to another AI agent (for example, the third AI agent 206C). This ensures that different aspects of the larger task 208 are handled by specialized AI agents, leveraging their individual strengths, and optimizing the overall execution efficiency. According to an implementation, the task management device 202 may monitor a collaborative execution of the plurality of subtasks. Furthermore, the task management device 202 may receive, for each subtask of the plurality of subtasks, a subtask execution result from the selected corresponding AI agent. The task management device 202 may then determine, for each subtask of the plurality of subtasks, a performance score for the corresponding AI agent based on the subtask execution result and the one or more determination parameters. Additionally, the task management device 202 may update a reputation score of the corresponding AI agent based on the determined performance score.

In a scenario where a global enterprise seeks to upgrade its Border Gateway Protocol (BGP) routing configurations across multiple data centers using Extended Range (XR) devices, the system 200 may coordinate the collaboration of multiple AI agents. These AI agents may possess specialized expertise in various aspects of BGP routing, XR device configurations, and network design validation. According to an implementation, the task management device 202 may dynamically allocate a specific role (subtask) to each AI agent based on their contextual capabilities, ensuring that the final configuration is optimized, scalable, and ready for seamless deployment. The task management device 202 may facilitate efficient execution through the bidding process 210, the task assignment process 212, the task execution process 214, the result validation process 216, and the reputation update process 218. This collaborative framework may support the development of a robust BGP routing configuration tailored to the global enterprise's network architecture.

In this example, the multiple AI agents may include an AI agent A, an AI agent B, and an AI agent C. The AI agent A may have extensive expertise in global BGP routing protocols, the AI agent B may be specialized in XR device configurations and known for developing robust and scalable network configurations, and the AI agent C may have expertise in network design and validation, ensuring configurations adhere to industry best practices and future-proofing standards.

The global enterprise may send a task to the task management device 202 to develop a new BGP routing configuration for XR devices. The task requires specialized knowledge in both BGP routing and XR device configurations, with the goal of enhancing global routing efficiency and aligning the configuration with the broader network strategy. The task management device 202 evaluates the task and recognizes the need for specialized skills in BGP routing, XR device configurations, and network design validation. Subsequently, the task management device 202 may initiate the bidding process 210 involving the identified AI agents, such as the AI agent A, the AI agent B, and the AI agent C. The AI agent A submits a task execution proposal focusing on its deep expertise in BGP routing, proposing a strategy to optimize intercontinental traffic flows and reduce latency. The AI agent B submits a proposal emphasizing its capacity to develop robust and scalable configurations tailored to XR devices, ensuring long-term resilience and growth potential. The AI agent C submits a proposal ensuring that the configuration complies with industry best practices, meets regulatory standards, and is designed with future scalability in mind.

Based on the contextual analysis and reputation scores, the task management device 202 evaluates the submitted task execution proposals. The task management device 202 may select the AI agent A to draft the core BGP routing strategy, ensuring the configuration enhances global routing efficiency. The AI agent B may be selected to translate the BGP routing strategy into a detailed configuration specific to XR devices, ensuring technical compatibility with the enterprise's infrastructure and scalability. The AI agent C may be selected to review and validate the final configuration, ensuring adherence to best practices, compliance with standards, and long-term reliability. The selected AI agents collaborate under the oversight of the task management device 202 to create a comprehensive and validated BGP routing configuration. The final configuration is stored and made ready for deployment at the customer's discretion when they are prepared. Additionally, the reputation of each AI agent is reviewed and updated based on their contributions.

The above scenario demonstrates the ability of the task management device 202 to effectively coordinate the efforts of multiple AI agents with specialized expertise in a collaborative manner to develop a high-quality, validated BGP routing configuration. By dynamically selecting AI agents based on their contextual fit, specialized capabilities, and reputation, the system 200 ensures that the final configuration is optimized, scalable, and ready for deployment according to the customer's needs. The collaborative task execution model, supported by the system 200, underscores its capacity to manage complex configuration tasks, delivering tailored solutions that meet the specific requirements of a global enterprise network. Ongoing performance evaluations and reputation updates ensure the system 200 continuously optimizes task execution and AI agent selection for future tasks.

According to various embodiments, the system 200 may enhance efficiency, accuracy, and adaptability by leveraging context-aware task distribution, reputation-based AI agent selection, and dynamic bidding mechanisms. The system 200 may seamlessly integrate multiple AI agents, potentially from different organizations, teams, or distributed across different geographic regions into a cohesive and highly efficient framework for distributed task execution. The system 200 may further enable streamlining and optimization of the task by dynamically selecting context-aware AI agents based on real-time performance and reputation scores.

Although a specific embodiment for the system for context-aware task allocation and reputation management of the AI agents, illustrating interactions between various components of the system 200, suitable for carrying out the various steps, processes, methods, and operations described herein is discussed with respect to FIG. 2, any of a variety of systems and/or processes may be utilized in accordance with embodiments of the disclosure. For example, the system 200 may support the selection of one or more AI agents, which may include sub-agents developed by different companies or teams. This flexibility enables the framework to leverage a diverse range of expertise and resources, optimizing task execution through collaboration among sub-agents within a unified AI agent entity. The elements depicted in FIG. 2 may also be interchangeable with other elements of FIG. 1 and FIGS. 3-13 as required to realize a particularly desired embodiment.

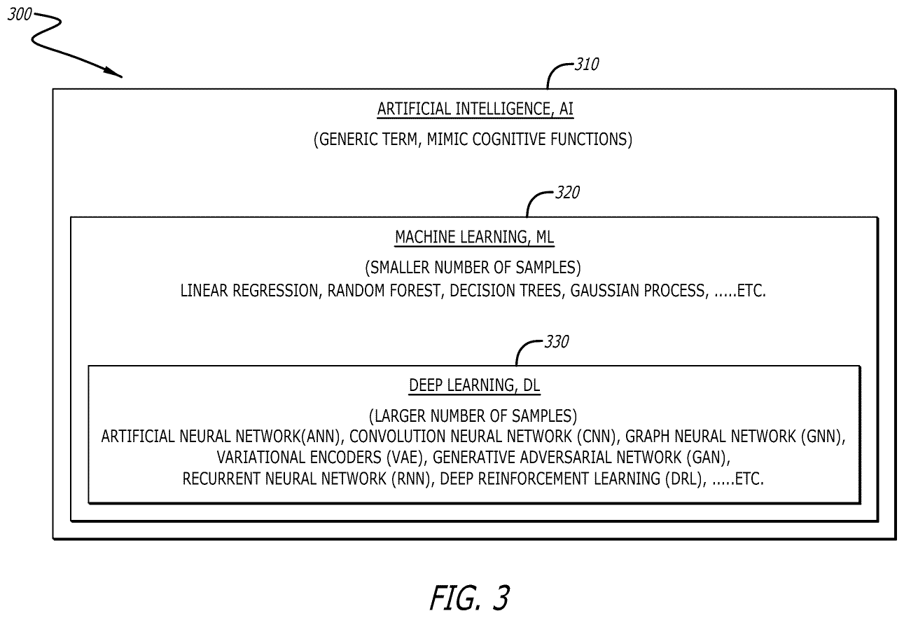

Referring to FIG. 3, a diagram 300 depicting various subsets of artificial intelligence in accordance with various embodiments of the disclosure is shown. Artificial intelligence (AI) 310 is typically understood in the art to be the development of machines and algorithms that mimic human intelligence, for example, by optimizing actions to achieve certain goals. At its core, AI 310 often involves designing algorithms and models that mimic cognitive functions, such as learning, reasoning, problem-solving, perception, and even language understanding. Unlike traditional computer programs that follow a fixed set of instructions, AI systems have the ability to adapt, improve, and make decisions based on input data and environmental interactions. AI 310 may be utilized to operate as an AI agent for executing automated tasks.

AI 310 can be considered a generic term because it encompasses a wide range of subfields and techniques, from simple rule-based systems to advanced machine learning and deep learning models. These AI techniques are used to simulate various aspects of human cognition. For example, machine learning (ML) 320 allows computers to learn from data patterns without explicit programming for each task, while natural language processing (NLP) enables machines to understand and generate human language. Deep learning (DL) 330, a more advanced branch of AI, uses neural networks to automatically learn complex patterns from large datasets, akin to the human brain's information processing. This versatility makes AI a powerful tool across diverse applications, including image recognition, autonomous driving, voice assistants, healthcare diagnostics, and materials discovery.

A goal of AI is often to create systems (e.g., AI agents) that can function autonomously and intelligently in real-world scenarios. As AI 310 continues to evolve, it can increasingly mirror human-like cognition, enabling machines to not just process data but to “think” in a way that can handle uncertainty, make predictions, and even interact with their surroundings in a meaningful manner. While AI systems are far from achieving the full breadth of human intelligence, their ability to replicate specific cognitive functions makes them invaluable in tackling complex, data-driven challenges.

Machine Learning (ML) 320 is a subset of Artificial Intelligence (AI) 310 that focuses on the development of algorithms and statistical models that enable computers (e.g., executing AI agents) to learn and make decisions from data without explicit programming. In traditional programming, a computer is given a fixed set of rules to follow, but ML 320 can shift this paradigm by allowing systems to identify patterns, adapt, and improve their performance based on the data they encounter. This data-driven approach makes ML particularly valuable for tasks that are too complex or dynamic to define using straightforward rules, such as, for example, recognizing images, predicting consumer behavior, or diagnosing diseases. In various embodiments described herein, machine-learning methods may be utilized to autonomously interpret, bid for, and execute tasks within a distributed system. These methods leverage contextual understand and decision-making capabilities to ensure precise and efficient task execution.

ML models can be configured to analyze large amounts of data to identify trends and relationships that inform their predictions or classifications. The process typically involves three stages: training, validation, and testing. During training, the model learns from a dataset by adjusting its internal parameters to minimize errors between its predictions and the actual results. Techniques like linear regression, decision trees, random forests, and Gaussian processes are commonly used in ML 320. These algorithms can handle various data types, including numerical, categorical, and structured datasets like spreadsheets or grids. One of the key strengths of ML is its ability to generalize from the training data to make accurate predictions on new, unseen data. In a number of embodiments described herein, training data may be generated from historical task execution data, reputation scores of AI agents, performance metrics of the AI agents, and other relevant sources.

However, traditional ML methods rely heavily on feature engineering, wherein human experts manually identify the most relevant features or patterns within the data. For example, when using ML 320 for image recognition, an expert might need to extract features like edges, textures, or color patterns before feeding them into a model. This requirement can limit the scalability of traditional ML approaches, especially when dealing with large, unstructured datasets such as images, text, or graphs. Additionally, ML algorithms may often work best when provided with relatively structured data, and they often need a reasonable amount of samples (typically more than 100) to learn effectively.

Deep Learning (DL) 330 is a specialized subset of Machine Learning (ML) 320 that employs multi-layered artificial neural networks to automatically learn complex patterns and representations from large, often unstructured datasets. Inspired by the way the human brain processes information, DL 330 consists of interconnected layers of “neurons” that can adaptively change as they are exposed to more data. Unlike traditional ML methods, which require manual feature engineering to identify key data characteristics, DL models can automatically extract features directly from raw data, such as images, text, or molecular structures. This automated feature extraction allows DL 330 to handle data types and tasks that were previously difficult or impossible for ML models to tackle effectively.

DL models, including Convolutional Neural Networks (CNNs), Graph Neural Networks (GNNs), and Recurrent Neural Networks (RNNs), excel at processing various forms of data. CNNs are particularly effective for image analysis, recognizing intricate patterns in visual inputs, making them indispensable in areas like materials science for analyzing microscopic images or detecting defects in materials. GNNs, on the other hand, are designed to work with graph-based data, such as molecular structures, social networks, or atomic interactions. They can learn the dependencies and relationships within graph-like structures, which is crucial for predicting properties of complex molecules and materials. RNNs and their variants, such as Long Short-Term Memory (LSTM) networks, are suited for sequential data like time series or natural language processing, allowing for the analysis and generation of textual information or the prediction of temporal patterns in scientific research.

One of the defining characteristics of deep learning is its requirement for large datasets (typically over 500 samples for example) to effectively train neural networks. The deep, multi-layered structure of these networks enables them to capture highly complex and abstract representations of the data, but it also demands significant computational power. Techniques like Variational Autoencoders (VAEs) and Generative Adversarial Networks (GANs) add to the versatility of DL by enabling the generation of new data samples that resemble the training set, aiding in areas such as materials discovery and synthetic data creation. Deep Reinforcement Learning (DRL) combines neural networks with decision-making processes to solve problems that involve optimization and control, further expanding DL's application potential. In summary, DL's ability to automatically learn from raw, unstructured data and model intricate patterns makes it a powerful tool in AI, particularly for complex domains like image recognition, natural language processing, and materials science.

Artificial Neural networks (ANNs or sometimes just NNs) are often a foundation of a DL system. The basic unit of a neural network is typically the perceptron, which can take inputs, assigns weights to these inputs, and combines them to produce an output. The final output is then passed through an activation function (such as, for example, ReLU, sigmoid, or hyperbolic tangent) to introduce non-linearity, which enables the network to model complex patterns.

Neural networks are typically trained through a process of backpropagation, where the system's predictions are compared against the known output, and a loss function is used to measure the difference between the prediction and the actual result. The network's weights can be adjusted through a process called gradient descent, which can be configured to minimize the loss function over time. However, the training process can be prone to problems like overfitting (where the model performs well on the training data but poorly on new data). To counter this, techniques such as regularization (e.g., regularization, dropout), early stopping, and mini-batches can be utilized to prevent the network from becoming overly specialized to the training set.

CNNs are a specific type of ML 320 neural network designed to work particularly well with image data, making them highly relevant AI agents for tasks related to image data. As those skilled in the art will recognize, CNNs typically use specialized layers known as convolutional layers, which apply filters (also known as kernels) to the input data. These filters slide over the input (e.g., an image), detecting patterns like edges or textures, which are then passed to the next layer for further processing. The advantage of CNNs is their ability to automatically learn and extract relevant features from raw data without the need for manual feature engineering. Furthermore, pooling layers (e.g., max-pooling or average pooling) are often added after convolutional layers to reduce the dimensionality of the data, helping to make the system more efficient while retaining the most important information. After several layers of convolutions and pooling, the CNN can output a task execution result, for example, classifying an image or generating a score suitable for evaluation for an image.

While CNNs are well-suited for grid-based data like images, many real-world problems in can involve non-grid data, such as financial transaction or network configurations. This type of data may better be represented as a graph, where nodes represent entities and edges represent relationships between them. Thus, Graph Neural Networks (GNNs) can be utilized to operate on such graph-based data.

In GNNs, information is passed between nodes through edges in a process called message passing. This allows the network to capture dependencies and relationships within the graph structure. The key feature of GNNs is their ability to aggregate information from neighboring nodes, which is important in predicting properties that depend on the current/local structure, such as the behavior of a network node.

Generative models aim to learn the underlying distribution of a dataset and generate new samples that resemble the original data. Two common types of generative models are Variational Autoencoders (VAEs) and Generative Adversarial Networks (GANs). VAEs are often configured to work by encoding data into a lower-dimensional latent space and then decoding it back into its original form. This allows for the generation of new data by sampling points from the latent space. This can be utilized when attempting to construct a potential task execution proposal, when executing an assigned task, or the like.

Similarly, GANs consist of two components: a generator that creates fake/generated data and a discriminator that tries to distinguish between real and fake data. The two components are trained in a competitive process where the generator tries to “fool” the discriminator, leading to increasingly realistic generated data. This type of process may be utilized to detect vulnerabilities in a system such as communication network.

Reinforcement Learning (RL) involves an agent learning to make decisions by interacting with an environment and receiving feedback (rewards or penalties) based on its actions. Deep Reinforcement Learning (DRL) combines RL with DL techniques, allowing agents to learn from high-dimensional inputs, such as network configurations or complex network simulations.

An AI agent leveraging DRL can be utilized in various scenarios requiring optimal decision making. For example, optimizing traffic routing policies or finding an optimal network path with reduced latency. The combination of RL and DL can allow for learning from raw data, making it a powerful tool for dynamic and real-time decision-making across a wide range of applications.

Although a specific embodiment for a diagram 300 depicting various subsets of artificial intelligence suitable for carrying out the various steps, processes, methods, and operations described herein is discussed with respect to FIG. 3, any of a variety of systems and/or processes may be utilized in accordance with embodiments of the disclosure. For example, other subset may be present and available for use within AI 310. Those skilled in the art will recognize that the diagram 300 presented in FIG. 3 is simplified for illustration purposes and various methods and techniques may interact with other areas (ML 320 with DL 330, etc.). The elements depicted in FIG. 3 may also be interchangeable with other elements of FIGS. 1-2 and 4-13 as required to realize a particularly desired embodiment.

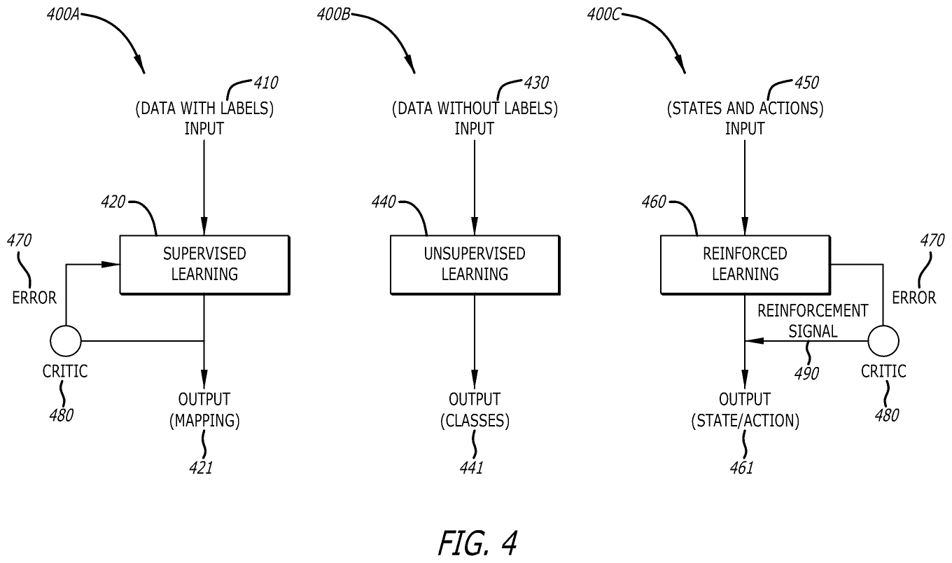

Referring to FIG. 4, different methods of machine-based learning in accordance with various embodiments of the disclosure are shown. In many embodiments, a machine learning model is defined as a mathematical representation of the output of the training process. A machine learning model is often considered similar to computer software designed to recognize patterns or behaviors based on previous experience or data. However, the learning algorithm can discover patterns within the training data, and output an ML model (e.g., an AI agent) which can capture these patterns and make predictions on new data.

ML models can be understood as a device (e.g., an AI agent) that has been trained to find patterns within new data and make predictions. These models can be represented as a complex mathematical function that would be impractical for a human to calculate that takes requests in the form of input data, makes predictions on input data, and then provides an output in response. First, these models can be trained over a set of data, and then they are provided an algorithm or other task to reason over data, extract the pattern from feed data and learn from that data. Once the model(s) is/are trained, they can be used to predict a new and previously unseen dataset.

There are various types of machine learning models available based on different business goals and data sets available. Often, based on the desired application, ML models can be configured as or settle into one of three different model types: supervised learning, unsupervised learning, and/or reinforcement learning. Supervised learning can further be broken down into two categories of classification and regression. Likewise, unsupervised learning can be divided into three categories: clustering, association rule, and/or dimensionality reduction.

In the embodiment depicted in FIG. 4, a supervised learning system 400A is shown. The supervised learning system 400A can be configured with a supervised learning model 420 that accepts input data 410 and generates an output 421. However, the output data is often reviewed by a critic 480 that can determine one or more errors 470 that are fed back into the supervised learning model 420 for use in updating.

Supervised learning systems 400A are often considered the simplest machine learning model to understand in which input data (such as training data) has a known label or result as an output. So, the supervised learning model 420 can be understood to work on the principle of input-output pairs. As such, a function can be trained using a training data set, which is then applied to unknown data and makes some predictive performance. Supervised learning is task-based and mostly tested on labeled data sets.

Supervised learning systems 400A may often involve one or more regression problems. In regression problems, the output is a continuous variable. Some commonly used Regression models include linear regression, decision trees, and random forests. Linear regression is typically the most straight forward machine learning model in which a prediction of one output variable is made using one or more input variables. The representation of linear regression can be processed as a linear equation, which combines a set of input values (denoted as x) and a predicted output (denoted as y) for the set of those input values. As those skilled in the art will recognize, this may be represented in the form of a line: Y=bx+c. A typical aim of a linear regression-based model can be to find the optimal fit line that best fits the available data points. Linear regression can be extended to multiple linear regressions (finding a plane of best fit in higher dimensional space) and polynomial regressions (finding the best fit curve).

Decision trees are also popular machine learning models that can be used for both regression and classification problems. A decision tree uses a tree-like structure of decisions along with their possible consequences and outcomes. In this, each internal node is used to represent a test on an attribute while each branch is used to represent the outcome of the test. The more nodes a decision tree has, the more accurate the result will be. This may be used when making decisions related to an assigned task, for example, developing a comprehensive, optimized BGP configuration that aligns with network's global architecture and preparing BGP configuration for seamless deployment at a later date. The advantage of decision trees is that they are intuitive and easy to implement, but may lack accuracy depending on the available computational or time resources available.

Random forests are an ensemble learning method, which may consist of a large number of decision trees. For example, each decision tree in a random forest predicts an outcome, and the prediction with the majority of votes is considered as the outcome. A random forest model can be used for both regression and classification problems. For the classification task, the outcome of the random forest may be taken from the majority of votes. Whereas in the regression task, the outcome can be taken from the mean or average of the predictions generated by each tree.

Classification models are another type of supervised learning, which can be used to generate conclusions from observed values in one or more categorical forms. For example, a classification model can identify if an email is spam or not; whether a task execution proposal is suitable for a task, etc. Classification algorithms can also be used to predict between two or more classes and/or categorize an output into different groups. For these classification systems, a classifier model can be designed that classifies the dataset into different categories, and each category can subsequently be assigned a label. As those skilled in the art will recognize, there are currently two main types of classifications in machine learning: binary and multi-class. Binary classification can be utilized when there are only two possible classes (i.e., yes/no, dog/cat, etc.). Multi-class classification can be utilized when there are more than two possible classes, thus requiring a multi-class classifier.

One of the potential classification processes is logistic regression. Logistic regression can be used to solve various classification problems in machine learning systems. These processes are similar to linear regression but are often used to predict categorical variables. While some variations can be configured to generate a prediction as an output in either “yes” or “no”, 0 or 1, “true” or “false”, etc. However, in some embodiments, the system can instead be configured to not give exact values, but instead provide probabilistic values between zero and one, etc.

Another classification process that can be utilized is a support vector machine (SVM) which is widely used for classification and regression tasks. However, the main aim of SVM is to find the best decision boundaries in an N-dimensional space, which can be utilized to segregate data points into classes, and generate a best decision boundary often known as a hyperplane. SVM processes can select the extreme vector to find a hyperplane, wherein these vectors are known as support vectors.

Naïve Bayes is another popular classification algorithm used in machine learning. This process receives its name as it is based on Bayes theorem and follows the naïve(independent) assumption between the features which is often given as the formula:

$$P ( y \vert X ) = \frac{P ( X \vert y ) * P ( y )}{P ( X )}$$

This formula takes a class or target y and a predictor attribute (X) and calculates a posterior probability P(y|X) of that class given a particular predictor. P(y) is the prior probability of that class, P(X) is the prior probability of the predictor, and P(X|y) is the likelihood or probability of the predictor given the class. As those skilled in the art will recognize, this may be more succinctly understood as the posterior chance being a result of the prior results times the likelihood divided by the evidence available. Each naïve Bayes classifier assumes that the value of a specific variable is independent of any other variable/feature. For example, if a fruit needs to be classified based on color, shape, and taste. So yellow, oval, and sweet will be recognized as mango. Here each feature is independent of other features. Likewise, various embodiments herein can classify based on task type, task context, reputation scores, etc.

Again, in the embodiment depicted in FIG. 4, an unsupervised learning system 400B is shown. The unsupervised learning system 400B can be configured with an unsupervised learning model 440 that accepts input data 430 and generates an output 441. Unlike other model types, there are no critics or error signals to process. Unsupervised learning models 440 can implement the learning process opposite to supervised learning, which means it enables the model to learn from an unlabeled training dataset. Based on the unlabeled dataset, the unsupervised learning model 440 can predict the output. Using an unsupervised learning system 400B, the unsupervised learning model 440 can learn hidden patterns from the dataset by itself without any supervision. In various embodiments, unsupervised learning models 440 are often utilized to perform tasks involving clustering, association rule learning, and/or dimensional reduction.

Clustering is an unsupervised learning technique that involves clustering or grouping the available data points into different clusters based on similarities and/or differences. The objects or data points with the most similarities remain in the same group, and they have no or very few similarities from other groups. Clustering algorithms can be used in a variety of different tasks such as, but not limited to image segmentation, statistical data analysis, market segmentation, and the like. Some commonly used clustering algorithms that can be selected include K-means Clustering, hierarchal Clustering, DBSCAN, etc.

Association rule learning is an unsupervised learning technique which finds unique relations among variables within a large data set. In many embodiments, a primary aim of this type of learning algorithm is to find the dependency of one data item on another data item and map those variables accordingly so that it can satisfy some desired outcome. For example, in certain embodiments, an association rule system may be utilized to generate a task execution proposal that aligns with a task. This algorithm can be applied in market basket analysis, web usage mining, continuous production, etc. However, those skilled in the art will recognize that other scenarios may be available based on the desired application. Some popular algorithms of association rule learning are Apriori Algorithm, Eclat, and FP-growth algorithm.

In additional embodiments, the number of features/variables present in a dataset can be understood as the dimensionality of the dataset, and the technique used to reduce the dimensionality is known as a dimensionality reduction technique. Although more data provides more accurate results, it can also affect the performance of the model/algorithm, such as yielding overfitting outcomes, etc. In such cases, dimensionality reduction techniques can be utilized. It is often desired that this process involves converting the higher dimensions dataset into lesser dimensions dataset while also ensuring that the ensuing results provide similar information. Different dimensionality reduction methods can be utilized, such as, but not limited to, PCA (Principal Component Analysis), Singular Value Decomposition (SVD), etc.

Finally, in the embodiment depicted in FIG. 4, a reinforcement learning system 400C is shown. The reinforcement learning system 400C can be configured with a reinforcement learning model 460 that accepts input data 450 and generates an output 461. In reinforcement learning, the reinforcement learning model 460 learns actions for a given set of states that lead to a goal state. In the embodiment depicted in FIG. 4, a critic 480 can receive or otherwise notice an error 470 within the reinforcement learning model 460 actions, and adjust the outcome/output by way of a reinforcement signal 490 such that the “reward” or “punishment” is adjusted to better model the future behaviors or processing of the reinforcement learning model 460.

It is a feedback-based learning model that can takes feedback signals after each state or action by interacting with the environment. This feedback works as a reward (positive for each good action and negative for each bad action), and the agent's goal is to maximize the positive rewards to improve their performance. The behavior of the model in reinforcement learning is similar to human learning, as humans learn things by experiences as feedback and interact with the environment. Popular methods of reinforcement learning including q-learning, state-action-reward-state-action (SARSA), and deep Q network.

Q-learning is one of the popular model-free algorithms of reinforcement learning, which is based on the Bellman equation. It often aims to learn the policy that can help the AI agent to take the best action for maximizing the reward under a specific circumstance. It can incorporate Q values for each state-action pair that indicate the reward to following a given state path, and it tries to maximize that Q-value.

SARSA is an on-policy algorithm based on the Markov decision process. In many embodiments, it can use the action performed by the current policy to learn the Q-value. The SARSA algorithm stands for State Action Reward State Action, which symbolizes the tuple (s, a, r, s′, a′). Finally, deep Q neural networking (or DQN) is Q-learning within a neural network. It can be deployed within a big state space environment where defining a Q-table would be a complex task. So, in these embodiments, rather than using a Q-table, the neural network instead utilizes Q-values for each action based on the state.

Although a specific embodiment for different methods of machine-based learning suitable for carrying out the various steps, processes, methods, and operations described herein is discussed with respect to FIG. 4, any of a variety of systems and/or processes may be utilized in accordance with embodiments of the disclosure. For example, those skilled in the art will recognize that methods of learning described herein are generalized and may incorporate other types developed as well as a combination of one or more methods based on the goals of the desired application. The elements depicted in FIG. 4 may also be interchangeable with other elements of FIGS. 1-3 and 5-13 as required to realize a particularly desired embodiment.

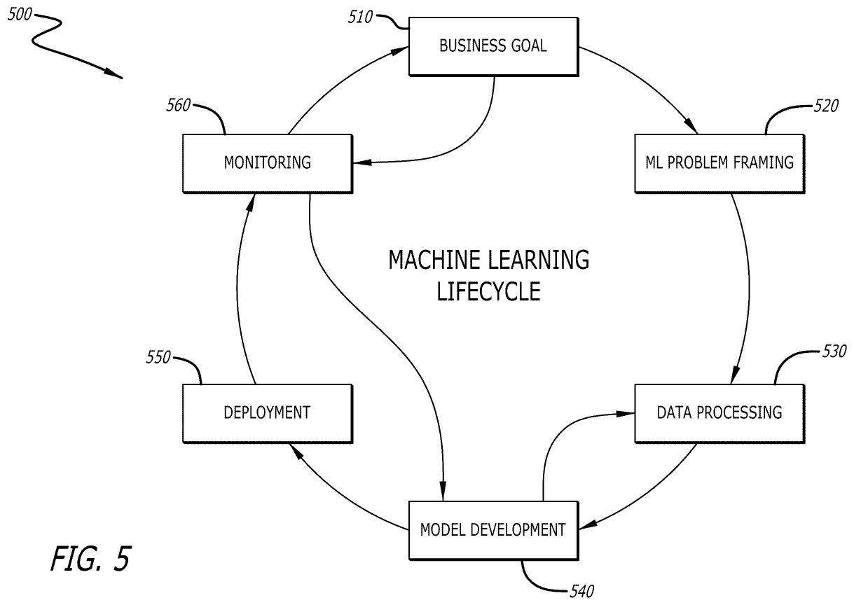

Referring to FIG. 5, a machine learning lifecycle 500 in accordance with various embodiments of the disclosure is shown. During the development of machine learning systems, the embodiment depicted in FIG. 5 can provide a framework for how to structure the design and maintenance of these systems This machine learning lifecycle 500 outlines various stages involved in building, deploying, and improving ML models to solve real-world problems. By following this structured process, businesses and organizations can ensure that their machine learning projects align with strategic goals, use data effectively, and adapt to changing conditions over time. This machine learning lifecycle 500 emphasizes that developing a machine learning model is not a one-time effort but an iterative process requiring ongoing monitoring and adjustment. The feedback loop inherent in the machine learning lifecycle 500 allows for continual refinement and optimization of models to maintain their accuracy and relevance.

In many embodiments, a first stage of the machine learning lifecycle 500 is identifying the business goal 510, which sets the overall direction and purpose of the ML project. This can involve understanding the specific problems or opportunities within the business or project that machine learning can address. A clear business goal 510 ensures that the project remains focused on delivering tangible value, whether it is involves streamlining task assignments, optimizing collaborative efforts in real-time operations, refining decision-making processes for dynamic environments, or autonomously adjusting to changing task requirements. Without a well-defined goal, it can be challenging to align the subsequent stages of the ML lifecycle 500, as the choice of model, data processing methods, and performance metrics can all depend on what the business aims to achieve.

Establishing a proper business goal 510 can also involve engaging with key stakeholders and developers to gather requirements and set success criteria. It can provide a roadmap that outlines what success looks like and helps in framing the ML problem. For example, if the goal is to optimize task execution, the project might focus on developing a predictive model that enables AI agents to interpret a task, adapt to dynamic conditions, and execute the task efficiently with high accuracy. Clearly defined goals not only help guide the project but also provide benchmarks for evaluating the effectiveness of the deployed model once it enters production.

Once the business goal 510 is established, various embodiments take a next step involving ML problem framing 520, wherein the goal is translated into a specific machine learning task. This can involve selecting the appropriate type of ML problem, such as classification, regression, clustering, or recommendation, and defining the target variables or outputs. For example, if the goal is to optimize how AI agents bid for and execute tasks in a distributed environment, the problem can be framed as a reinforcement learning task where the model predicts the likelihood of an AI agent's bid (a task execution result) being selected based on its performance history, reputation, and the task's context. Proper problem framing can be important as it determines the particular data requirements, choice of model, and evaluation metrics.

During this stage, it is also prudent to consider the constraints and assumptions that may affect the model's development. This might include data availability, computational resources, ethical considerations, or regulatory compliance. Properly framing the problem ensures that the model development aligns with the business's needs and that the problem is broken down into manageable steps, ultimately increasing the project's chances of success.

Data processing 530 is a step in many embodiments where raw data is collected, cleaned, and transformed into a format suitable for machine learning. This step can involve gathering data from various sources, removing errors or inconsistencies, handling missing values, and normalizing or scaling features to ensure that the model can learn effectively. Feature engineering is often a part of this stage, where new features are derived from the raw data to capture more relevant information and improve model performance.

The quality and preparation of the utilized data can significantly impact the model's accuracy and reliability. Inadequate or poorly processed data can lead to biased or inaccurate predictions, no matter how advanced the model is. Hence, data processing 530 can require or at least benefit from careful planning and iterative refinement. Once the data is processed, it is typically split into training, validation, and test sets to develop and evaluate the model, ensuring that it generalizes well to new, unseen data.

Model development 540 is a phase in a number of embodiments where machine learning algorithms are selected, trained, and refined to create a model that addresses the framed problem. This stage can involve choosing the appropriate algorithm (e.g., decision trees, neural networks, support vector machines), setting up the model's architecture, and defining hyperparameters that will guide the training process. The model is trained on the processed data to identify patterns and relationships that allow it to make predictions or decisions.

During model development 540, the model can be evaluated using the validation dataset to fine-tune its parameters and improve performance. Techniques like cross-validation, regularization, and hyperparameter tuning can be used to prevent overfitting and ensure the model generalizes well. If proper steps are taken, the result is a model that, once it meets predefined performance metrics, is ready for deployment in a real-world environment. However, this process often involves several iterations to optimize the model for the specific business goal, indicated by the arrow back to data processing 530.

In further embodiments, deployment 550 is the stage where the developed model is integrated into the production environment to perform its intended tasks. This phase may involve setting up the necessary infrastructure, such as APIs or cloud-based services, to allow the model(s) to process live data and generate predictions. Deployment 550 can transform the model from a research tool into a functional component of a business process or product, providing real-time insights, automations, or decisions.

Proper deployment 550 can also include setting up mechanisms for logging, error handling, and user access. Since real-world environments are often dynamic and differ from training conditions, deployment may require continuous adaptation and updates to ensure the model(s) operates efficiently. This step can be important because a model's success is not only determined by its performance metrics but also by its ability to provide actionable results that align with the business goal 510.

In more embodiments, monitoring 560 is the ongoing process of tracking the model's performance and behavior after deployment. It involves collecting data on the model's predictions, accuracy, latency, and error rates to detect issues such as concept drift, where changes in the underlying data patterns can degrade the model's accuracy. By continuously monitoring 560, teams can identify when the model's performance drops and requires retraining or adjustments to align with the evolving data.

Monitoring 560 can also encompass aspects like user feedback, security, and compliance, ensuring that the model remains effective, reliable, and ethical in its application. It may serve as the feedback loop in the lifecycle, where insights gained from monitoring feed back into the earlier stages, particularly data processing 530 and model development 540, to refine the model(s) as needed. This iterative process allows the machine learning system to adapt and maintain its alignment with the original business goal 510 over time.

Although a specific embodiment for a machine learning lifecycle 500 suitable for carrying out the various steps, processes, methods, and operations described herein is discussed with respect to FIG. 5, any of a variety of systems and/or processes may be utilized in accordance with embodiments of the disclosure. For example, the particular route of development of the model(s) may not follow this cycle completely. As those skilled in the art will recognize, there are a variety of ways to develop AI products that include various iterative steps that aide in development and refinement of different model(s). The elements depicted in FIG. 5 may also be interchangeable with other elements of FIGS. 1-4 and 6-13 as required to realize a particularly desired embodiment.

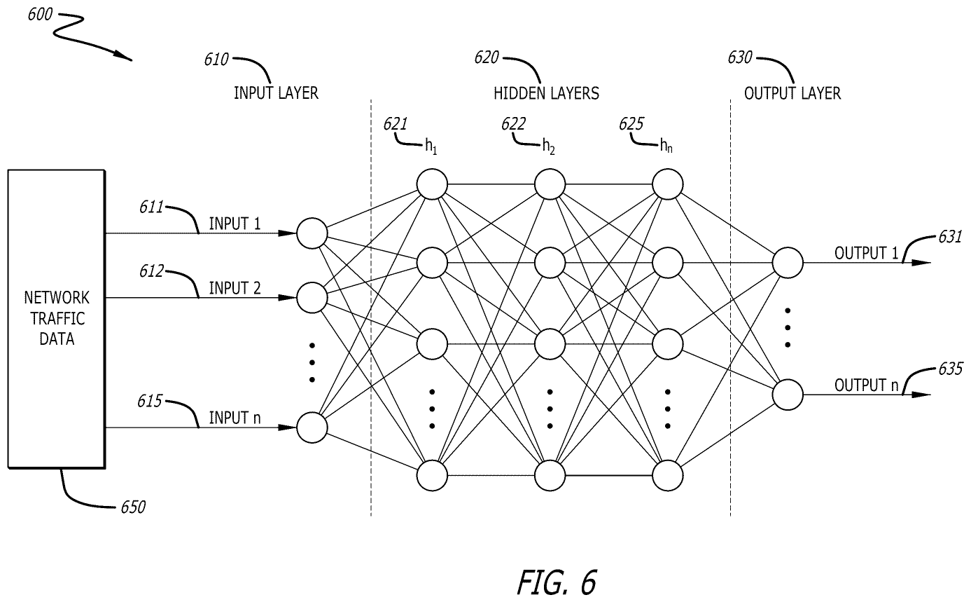

Referring to FIG. 6, an exemplary neural network 600 in accordance with various embodiments of the disclosure is shown. The embodiment depicted specifically depicts a feedforward neural network with multiple layers. This type of network consists of an input layer 610, one or more hidden layers 620, and an output layer 630. Each layer contains nodes (or neurons) that are interconnected, representing how data flows through the network. The input layer 610 can receive raw data, which is then processed by the hidden layers 620 through weighted connections and activation functions. These hidden layers 620 can enable the network to learn complex patterns and relationships within the data.

The final output layer 630 produces the network's predictions or classifications based on the processed input. The interconnected nature of the nodes allows the neural network 600 to learn from data during training by adjusting the weights of connections to minimize prediction errors. This structure is the foundation of deep learning models, as adding more hidden layers 620 can create a deep neural network, capable of tackling highly complex tasks such as image recognition, natural language processing, and pattern detection in large datasets

A perceptron or a single artificial neuron is the building block of artificial neural networks (ANNs) and can perform forward propagation of information. For a set of inputs to the perceptron, weights (and biases to shift wights) can be assigned. These inputs and weights can be multiplied out correspondingly together to get a sum output. Those skilled in the art will recognize tools such as, but not limited to, PyTorch, Tensorflow, and MXNet as training packages for common neural network tasks. However, it is contemplated that other tools may be developed specifically for the neural network tasks related to the embodiments described herein.

In additional embodiments, the weight matrices of a neural network can be initialized randomly or obtained from a pre-trained model. These weight matrices can be multiplied with the input matrix (or output from a previous layer) and subjected to a nonlinear activation function to yield updated representations, which are often referred to as activations or feature maps. The loss function (also known as an objective function or empirical risk) can often be calculated by comparing the output of the neural network and the known target value data.

Feedforward networks, such as the neural network 600 depicted in the embodiment of FIG. 6, are often configured as neural networks where information moves in one direction, from the input layer through the hidden layers to the output layer, without any cycles or loops. They are primarily used for tasks such as classification, regression, and simple pattern recognition, where each input is processed independently of others. In contrast, backpropagation is not a separate type of network but rather a training algorithm commonly used in both feedforward and other types of networks, like recurrent neural networks (RNNs).

Backpropagation involves adjusting the weights of the network in the reverse direction (from output to input) based on the error between the predicted output and the actual target during training. While feedforward describes the structure and data flow within the network, backpropagation is a technique used to optimize the model. Feedforward networks are ideal for straightforward tasks where input-output relationships are not sequential or time-dependent. However, for problems involving learning complex patterns over time, such as speech recognition or time-series analysis, networks that leverage backpropagation for training, like RNNs or deep feedforward networks with many hidden layers, become necessary to capture these intricate dependencies.

Typically, in these network arrangements, the weights are iteratively updated via various methods including, but not limited to, stochastic gradient descent algorithms in order to help minimize the loss function until the desired accuracy is achieved. Most modern deep learning frameworks can facilitate this by using reverse-mode automatic differentiation to obtain the partial derivatives of the loss function with respect to each network parameter through recursive application of the chain rule. Colloquially, this is also known as back-propagation. Common gradient descent algorithms can include, but are not limited to, Stochastic Gradient Descent (SGD), Adam, Adagrad etc. The learning rate is an important parameter in gradient descent. Except for SGD, all other methods use adaptive learning parameter tuning. Depending on the objective such as classification or regression, different loss functions such as Binary Cross Entropy (BCE), Negative Log Likelihood Loss (NLLL) or Mean Squared Error (MSE) can be used.

Neural network architecture is commonly used for a wide range of tasks in fields such as computer vision, natural language processing, financial forecasting, and materials science. For instance, it can be employed to recognize patterns in images, such as identifying objects or faces, or to classify text into categories, like spam detection in emails. It is also useful in regression problems, such as predicting stock prices or energy consumption, where input features can be processed to output continuous values. However, this is a general example of an artificial intelligence (AI) model, illustrating how a feedforward neural network works. Depending on the problem, other methods and models may be more appropriate. For example, convolutional neural networks (CNNs) are often used for image processing tasks, while recurrent neural networks (RNNs) are suitable for sequential data like time series data or text. Additionally, simpler models like linear regression, decision trees, or support vector machines (SVMs) may be sufficient if the problem is less complex, or the dataset is relatively small. The embodiment depicted in FIG. 6 is presented as an exemplary ML solution that may be deployed within one or more methods or systems described herein.

In many embodiments, the input layer 610 is the first layer in a neural network 600 and serves as the initial point where raw data is introduced into the model. Each node (or neuron) in this layer represents an individual feature or variable from the dataset, allowing the network to receive and process various types of data, such as pixel values in an image, numerical features in a spreadsheet, or words in a text document. For instance, in image recognition tasks, the input layer can consist of nodes that correspond to the pixel values of the image, providing the network with the visual information needed to identify objects or patterns. The number of nodes in the input layer directly depends on the number of features present in the dataset. If there are one-hundred features in the data, the input layer will typically have one-hundred nodes, each conveying one piece of the information to the subsequent layers. In more embodiments, the inputs of the neural network 600 are generally scaled i.e., normalized to have a zero mean and/or unit standard deviation. Scaling can also be applied to the input of hidden layers (using batch or layer normalization) to improve the stability of neural network 600.

Unlike the hidden layers 620 and output layers 630, the input layer 610 typically does not perform any computations or transformations on the data. Its primary function is often to pass the input data to the next layer in the network, the first hidden layer 621. However, it is often desired that the data fed into this layer is preprocessed appropriately, such as being normalized or standardized, to ensure that the neural network can learn efficiently. Proper preprocessing, like scaling numerical values or encoding categorical variables, can help the network process data uniformly, facilitating more stable and faster convergence during training.

The input layer's design depends on the nature of the problem. For example, in natural language processing, the input layer may represent words encoded as numerical vectors, while in time-series analysis, each node might represent a data point in a sequence. While the input layer 610 itself does not modify the data, it sets the stage for the neural network to extract complex patterns and relationships through the deeper layers. This flexibility in handling various types of input make the neural network 600 a powerful tool for a diverse set of applications.

With respect to the embodiments described herein, the input layer may be configured with a plurality of inputs providing task data 650, AI agent attributes/parameters, or other sources of task-related information. For example, a model can be configured with a first input layer 611 configured as a context-aware task to be assigned to a specific AI agent, a second input 612 is configured as attributes/parameters of a first AI agent, while additional inputs can be added related to the number of available AI agents in the system. The nth input 615 can be configured in certain embodiments to include attributes/parameters of nth AI agent. However, as those skilled in the art will recognize, additional setups can be configured such that the inputs can be configured to also include different parameters such as contextual relevance of the task, the dynamic reputation scores of AI agents, the complexity of tasks, priority of tasks in the system, and/or performance metrics derived from prior task analyzes.

In a number of embodiments, the neural network 600 comprises a plurality of hidden layers 620. The embodiment depicted in FIG. 6 comprises a first hidden layer 621, a second hidden layer 622, and an nth hidden layer 625, which are denoted as h₁, h₂, and hₙ respectively. In many embodiments, the hidden layers 620 are where the core of the model's learning and pattern recognition occurs. In each hidden layer, individual neurons receive inputs from the previous layer, apply a set of weights, add a bias, and pass the result through an activation function (e.g., ReLU, leaky ReLU, sigmoid, hyperbolic tangent (tanh), Swish, etc.). This process can introduce non-linearity, allowing the network to capture complex patterns in the data that simple linear models cannot. The intricate web of connections among neurons across layers helps the network transform and process input features into representations that become progressively more abstract and useful for making predictions.

The first hidden layer 621 h₁ receives direct input from the input layer, transforming the raw data into an initial set of features. For example, in an image recognition task, this layer might begin identifying basic patterns, such as edges or simple textures. The output of the first hidden layer 621 is then passed to a second hidden layer 622 h₂, which builds upon the features identified by the first hidden layer 621. This deeper layer might start recognizing more complex patterns, such as shapes or specific object components, by combining the lower-level features identified earlier. This can continue on until a last, nth hidden layer 625 hₙ continues this abstraction process, allowing the network to recognize even higher-level, more detailed features, such as identifying an entire object within an image or understanding intricate relationships in the input data.

Each hidden layer adds a level of complexity and abstraction to the network's learning capabilities. The multi-layer structure can enable the network to move from recognizing simple patterns in the first input layer 611 to highly complex, abstract concepts in the deeper layers. The number of hidden layers and neurons within them can vary depending on the problem's complexity. More hidden layers generally allow the network to model more intricate functions, making deep neural networks especially effective for tasks like image recognition, natural language processing, and complex predictive modeling. However, adding more layers also increases the computational demand and the risk of overfitting, highlighting the need to carefully design and tune these hidden layers for optimal performance.

In various embodiments, the output layer 630 is often the final layer in a neural network and is responsible for producing the network's predictions or classifications based on the information processed through the previous hidden layers 620. Each neuron in the output layer 630 can represent a specific outcome or category that the model can predict. In the embodiment depicted in FIG. 6, the outputs are labeled as “output 1” 631 to “output n” 635, indicating that the network can be designed to have a varying number of outputs depending on the nature of the problem being solved for. For example, in a binary classification task (e.g., choosing to accept or decline a task), there would typically be a single output neuron that provides a probability score for one of the two classes/outcomes. In contrast, for multi-class classification (e.g., selecting the most suitable action or strategy from several options), the output layer would contain multiple neurons, each corresponding to a different class.

The number of neurons in the output layer 630 can also designed specifically for other types of tasks, such as regression, where the model can predict continuous values. In such cases, the output layer 630 might contain a single neuron representing a numerical prediction, such as the price of a house or the temperature forecast, etc. Alternatively, in complex applications like multi-label classification (where each input can belong to multiple classes simultaneously), the output layer 630 could have multiple neurons, each representing a different class, with each neuron outputting a probability of the input belonging to that specific class.

The activation function used in the output layer can vary based on the desired output. For binary classification, a sigmoid function is commonly used to produce a probability between 0 and 1. For multi-class classifications, a softmax function can be applied to output a set of probabilities that sum to 1, indicating the most likely class. For regression problems, a linear activation function is often used to output a continuous range of values. The flexibility in designing the output layer allows the neural network 600 to be applied to a wide variety of tasks, from simple binary decisions to complex multi-output predictions, making them a versatile tool in artificial intelligence and machine learning.

Although a specific embodiment for an exemplary neural network suitable for carrying out the various steps, processes, methods, and operations described herein is discussed with respect to FIG. 6, any of a variety of systems and/or processes may be utilized in accordance with embodiments of the disclosure. For example, real-world neural networks are often far more complex, featuring many more layers, nodes, and connections than the simplified structure shown in the embodiment depicted in FIG. 6, which is an illustrative example meant to make it easier to explain the basic concepts of neural networks and how they process information. The specific features and functions described herein are not intended to be limiting to this specific embodiment. Additionally, the elements depicted in FIG. 6 may also be interchangeable with other elements of FIGS. 1-5 and 6-13 as required to realize a particularly desired embodiment.

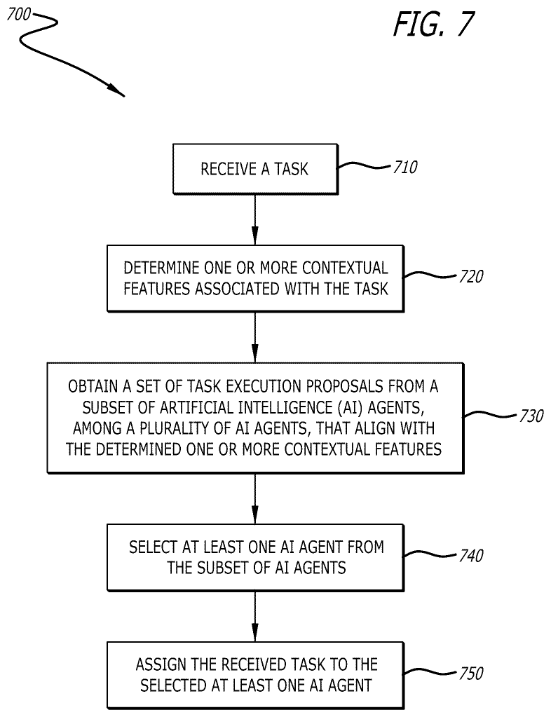

Referring to FIG. 7, a flowchart depicting a process 700 for task assignment to AI agents based on contextual features and task execution proposals in accordance with various embodiments of the disclosure is shown. In many embodiments, a task may refer to an operation that can be assigned to one or more AI agents for execution, with the goal of achieving a specific outcome, such as processing, computation, or service delivery. Further, an AI agent is a composite, autonomous software entity designed to perform specific tasks within a distributed network architecture. The AI agent may include multiple sub-agents, which may be developed by different entities or internal teams. These sub-agents may collaborate under the control of a primary AI agent, allowing the AI agent to execute tasks more efficiently by leveraging the specialized capabilities of each sub-agent. According to an embodiment, the AI agent may operate based on an AI model that governs decision-making process of the AI agent, along with a set of tools that enable the AI agent to interpret and execute tasks. Together, the AI model and tools allow the AI agent to understand the nature of a given task, assess feasibility of the task, and take the necessary actions to complete the task.

In a variety of embodiments, the process 700 may receive a task (block 710). In several embodiments, the process 700 may receive the task from an external source. Examples of the external source may include, but are not limited to, an external system, a user input, an external Application Programming Interface (API), or a web service. In various embodiments, the process 700 may create the task itself, rather than receiving the task from the external source. For example, the process 700 may generate the task in response to specific events or triggers, such as arrival of new data, completion of a prior task, or detection of an issue within a system.

In further embodiments, the process 700 may determine one or more contextual features associated with the task (block 720). The one or more contextual features may refer to specific characteristics or attributes related to the task that influence how the task should be assigned, executed, and/or managed. In many examples, the one or more contextual features may correspond to at least one of a task type, one or more requirements of the task, or security requirements. In some embodiments, the process 700 may utilize Natural Language Processing (NLP) techniques or other appropriate information extraction mechanisms to analyze and interpret the received task, enabling the extraction of one or more contextual features.

In still yet more embodiments, the process 700 may obtain a set of task execution proposals from a subset of AI agents, among a plurality of AI agents, that align with the determined one or more contextual features (block 730). A task execution proposal may represent a bid from an AI agent, in which the AI agent outlines the proposed strategy for executing a task. The task execution proposal may include the approach taken by the AI agent to fulfil the task, such as the execution method, expected duration, reputation score, required computational resources, and any associated costs. In various embodiments, the process 700 may transmit a query to the subset of AI agents for submission of the set of task execution proposals for the received task, where the set of task execution proposals is obtained as a response from the subset of AI agents for the transmitted query.

In further additional embodiments, the process 700 may select at least one AI agent from the subset of AI agents (block 740). The selection may be based on an evaluation of the set of task execution proposals. In many further embodiments, the process 700 may evaluate the obtained set of task execution proposals against one or more evaluation parameters. These evaluation parameters may include, but are not limited to, a task execution time, a task execution cost, resource efficiency, and a reputation score. In more embodiments, the process 700 may compare the task execution proposals received from the subset of AI agents and select the most suitable task execution proposal and the corresponding AI agent.

In a variety of embodiments, the process 700 may assign the received task to the selected at least one AI agent (block 750). In various embodiments, the process 700 may assign the received task to the selected at least one AI agent based on capabilities and current operational state of the selected at least one AI agent, ensuring alignment with the specific requirements of the task. By assigning the task to the most suitable AI agent, the overall accuracy and efficiency of task execution are enhanced.

Although a specific embodiment for the process 700 for task assignment to the AI agents based on the contextual features and the task execution proposals suitable for carrying out the various steps, processes, methods, and operations described herein is discussed with respect to FIG. 7, any of a variety of systems and/or processes may be utilized in accordance with embodiments of the disclosure. For example, prior to obtaining the set of task execution proposals from the subset of AI agents, the subset of AI agents may be identified based on the determined one or more contextual features. The elements depicted in FIG. 7 may also be interchangeable with other elements of FIGS. 1-6 and FIGS. 8-11 as required to realize a particularly desired embodiment.

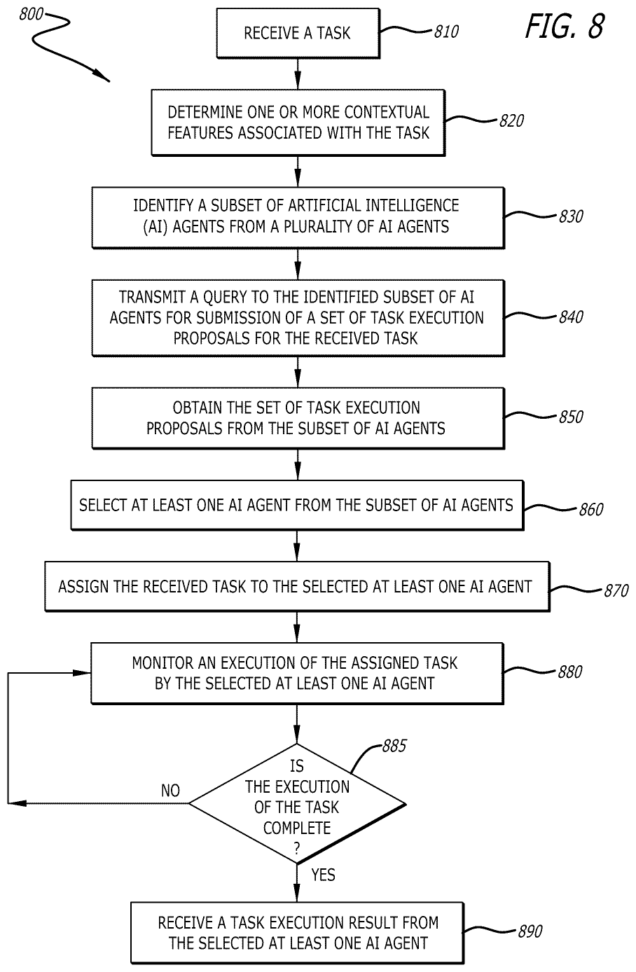

Referring to FIG. 8, a flowchart depicting a process 800 for assigning a task to AI agents and monitoring task execution in accordance with various embodiments of the disclosure shown. An example of the task includes a fraud detection operation, where transactional data is to be analyzed to identify fraudulent activities within a financial system. In many examples, a task can be to identify new vulnerabilities in a critical software system. In further examples, a task may include upgrading BGP routing configurations across multiple data centers using XR devices. Likewise, there can be many such examples of tasks that need to allocated or assigned for autonomous execution, for example, without human intervention by AI agents.

In a variety of embodiments, the process 800 may receive a task (block 810). In some examples, the task may be received for assignment to at least one AI agent from a plurality of AI agents. In one or more embodiments, the process 800 may receive the task from an external source, such as an external system, a user input, an external API, or a web service. In further embodiments, the process 800 may generate the task internally, rather than receiving the task from an external source. For example, the process 800 may generate the task based on specific conditions or events, such as a change in system status, detection of an anomaly, or need to process accumulated data.

In many further embodiments, the process 800 may determine one or more contextual features associated with the task (block 820). The one or more contextual features may represent key attributes or characteristics of the task that guide how the task should be assigned, carried out, and managed. Examples of contextual features may include task type, specific requirements associated with the task, or any security considerations. In some more embodiments, the process 800 may utilize data processing techniques, pattern recognition algorithms, or other suitable information extraction methods to analyze the task, enabling the extraction of relevant contextual features.

In yet more embodiments, the process 800 may identify a subset of AI agents from the plurality of AI agents (block 830). The process 800 may identify the subset of AI agents from the plurality of AI agents based on the determined one or more contextual features associated with the task. In many further embodiments, the process 800 may evaluate and filter the plurality of AI agents by assessing their operational context and current availability in relation to the contextual features of the task. The process 800 may then select those AI agents whose situational context aligns most closely with the task requirements, for example, beyond a set similarity threshold.

In numerous additional embodiments, the process 800 may transmit a query to the identified subset of AI agents for submission of a set of task execution proposals for the received task (block 840). A task execution proposal may represent a bid from an AI agent, outlining the proposed strategy for executing the task. The task execution proposal may include the approach for fulfilling the task, such as the execution method, expected duration, reputation score, required computational resources, and any associated costs.

In a number of embodiments, the process 800 may obtain the set of task execution proposals from the subset of AI agents (block 850). The process 800 may obtain the set of task execution proposals as a response to the transmitted query sent to the identified subset of AI agents. In one or more embodiments, each AI agent may submit a task execution proposal detailing the suggested approach for executing the task. The task execution proposals may include relevant information such as the method of task execution, anticipated time for completion of the task, computational resources required, potential risks, and the estimated costs associated with performing the task.

In many more embodiments, the process 800 may select at least one AI agent from the subset of AI agents (block 860). The process 800 may select the at least one AI agent from the subset of AI agents based on evaluation of the set of task execution proposals. In still more embodiments, the process 800 may evaluate the obtained set of task execution proposals against one or more evaluation parameters. The one or more evaluation parameters may include at least one of a task execution time, a task execution cost, a resource efficiency, or a reputation score. Task execution time refers to the total duration required to complete a task or subtask, from initiation to completion. Task execution cost refers to the total cost incurred during the execution of a task or subtask. Resource efficiency may reflect the optimal utilization of resources, such as memory, processing power, and network bandwidth, necessary for performing a task or subtask. Reputation score refers to a numerical value or rating that represents an AI agent's past performance, derived from historical task executions. In yet various embodiments, the process 800 may evaluate the obtained set of task execution proposals against the one or more evaluation parameters to ensure that the task is allocated to suitable AI agent(s).

In additional embodiments, the process 800 may assign the received task to the selected at least one AI agent (block 870). The task may be assigned to the most suitable AI agent to ensure optimal operation of the process 800 by utilizing the AI agent's capabilities, available resources, past performance, and other relevant factors. In an example, the “most suitable AI agent” may correspond to an AI agent that exhibits highest capability to meet the task requirements, considering factors such as computational resources, specialization in relevant domains, historical accuracy or success rate in similar tasks, and availability at the required time. This ensures the agent's optimal alignment with process 800's operational goals. This results in more efficient and effective task execution, with delays minimized, resource wastage reduced, and task success maximized.

In further additional embodiments, the process 800 may monitor an execution of the assigned task by the selected at least one AI agent (block 880). The process 800 may perform real-time monitoring of the task execution to ensure that the selected at least one AI agent adheres to assigned parameters, meets performance expectations, and completes the task within the desired constraints. In several embodiments, the process 800 may continuously collect data on the task progress from the selected at least one AI agent. In several more embodiments, the process 800 may be in a continuous feedback loop with the selected at least one AI agent, providing the opportunity to take corrective actions, optimize resource allocation, and address any unforeseen issues.

In many additional embodiments, the process 800 may determine whether the execution of the task has been completed (block 885). In a variety of embodiments, the AI agent executing the task is required to provide feedback. This feedback may include a completion status, which indicates whether the task has been successfully completed. The status may be reported as “success”, “failure”, or “in-progress”. If the task is reported as “success”, the process 800 may proceed to determine that task execution is complete. In some embodiments, the process 800 may also monitor an elapsed time since the task was assigned. If the task has exceeded an expected completion time (such as a deadline or expected duration), the process 800 may consider the task to be complete. If the task is not completed within the expected time, the process 800 may flag the task as overdue. In response to determining that the execution of the task has not yet been completed, in further embodiments, the process 800 may continue to monitor the execution of the assigned task by the selected at least one AI agent (block 880).

In response to determining that the execution of the task is complete, in yet further embodiments, the process 800 may receive a task execution result from the selected at least one AI agent (block 890). The task execution result may refer to the outcome or report provided by the selected at least one AI agent after completing the assigned task. The task execution result includes various metrics that reflect how the task was performed, such as the completion status (success or failure), the actual time taken to complete the task, resource utilization, and adherence to predefined task requirements or performance criteria. In numerous embodiments, the process 800 may evaluate performance of the selected at least one AI agent based on the task execution result.

Although a specific embodiment for a process 800 for assigning a task to AI agents and monitoring task execution suitable for carrying out the various steps, processes, methods, and operations described herein is discussed with respect to FIG. 8, any of a variety of systems and/or processes may be utilized in accordance with embodiments of the disclosure. For example, the process 800 may determine a performance score for the selected at least one AI agent based on the task execution result and one or more determination parameters such as one or more of an actual task execution time or an actual resource efficiency. The elements depicted in FIG. 8 may also be interchangeable with other elements of FIGS. 1-7 and FIGS. 9-13 as required to realize a particularly desired embodiment.

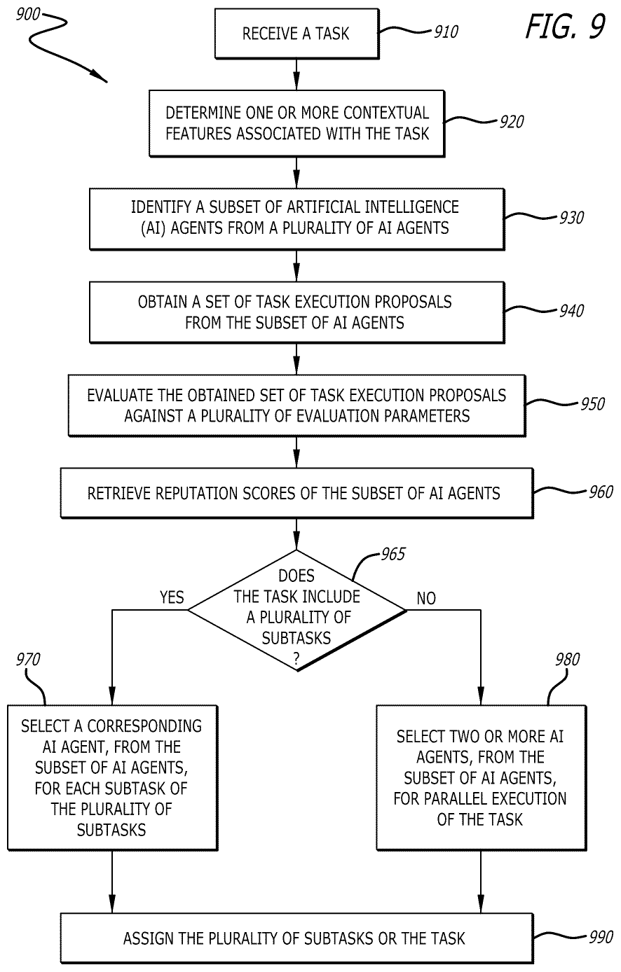

Referring to FIG. 9, a flowchart depicting a process 900 for assigning a task or subtasks to AI agents based on reputation scores of the AI agents in accordance with various embodiments of the disclosure is shown. A reputation score may refer to a numerical value or rating that represents past performance of an AI agent, derived from historical task executions. The reputation score may be determined by evaluating factors such as task completion accuracy, timeliness, resource usage, and adherence to specified requirements. In a scenario if a first reputation score of a first AI agent is higher than a second reputation score of a second AI agent, it may indicate a more consistent history of successful task completion by the first AI agent as compared to the second AI agent, signifying greater reliability and confidence in the first AI agent's ability to meet performance standards and requirements for future task assignments.

In a variety of embodiments, the process 900 may receive a task (block 910). In some examples, the task may be received for assignment to at least one AI agent from a plurality of AI agents. An example of the task includes a fraud detection operation, where transactional data is to be analyzed to identify fraudulent activities within a financial system. In one or more embodiments, the process 900 may receive the task from an external enterprise.

In further embodiments, the process 900 may determine one or more contextual features associated with the task (block 920). The one or more contextual features may represent key attributes or characteristics of the task that guide how the task should be assigned, carried out, and managed. Examples of contextual features may include task type, specific requirements associated with the task, or any security considerations. In examples, contextual features for a fraud detection task may include transaction type, account holder's historical activity, and any previous fraudulent activity associated with the account.

In more embodiments, the process 900 may identify a subset of AI agents from the plurality of AI agents (block 930). The process 900 may identify the subset of AI agents from the plurality of AI agents based on the determined one or more contextual features associated with the task. In further embodiments, the process 900 may evaluate and filter the plurality of AI agents by assessing their operational context and current availability in relation to the contextual features of the task. The process 900 may then select those AI agents whose situational context aligns most closely with the task requirements.

In numerous additional embodiments, the process 900 may obtain a set of task execution proposals from the subset of AI agents (block 940). A task execution proposal represents a bid from an AI agent, outlining the proposed strategy for executing the task. In an embodiment, the process 900 may transmit a query to the subset of AI agents for submission of the set of task execution proposals for the received task. The process 900 may obtain the set of task execution proposals as a response to the transmitted query sent to the identified subset of AI agents.

In many further embodiments, the process 900 may evaluate the obtained set of task execution proposals against a plurality of evaluation parameters (block 950). The one or more evaluation parameters may include at least one of a task execution time, or a task execution cost, or a resource efficiency.

In additional embodiments, the process 900 may retrieve reputation scores of the subset of AI agents (block 960). In various embodiments, the process 900 may retrieve the reputation scores of the subset of AI agents from a database. For example, the process 900 may query the database to obtain the reputation scores of the subset of AI agents. In further examples, the process 900 may send a query to the subset of AI agents to retrieve the reputation scores.

In further additional embodiments, the process 900 may determine whether the task includes a plurality of subtasks (block 965). In one or more embodiments, the process 900 may analyze the structure of the task to determine whether the task includes the plurality of subtasks. In an example, the task includes a fraud detection operation, where transactional data is to be analyzed to identify fraudulent activities within a financial system. The task may include, but not limited to, four subtasks including a first subtask, a second subtask, a third subtask, and a fourth subtask. The first subtask includes identifying patterns in transactional data to detect anomalies that could indicate fraudulent behavior. The second subtask includes flagging transactions that exceed specific risk thresholds for further review. The third subtask includes analyzing flagged transactions to assess the likelihood of fraud. The fourth subtask includes reporting suspicious activities for further investigation by relevant authorities or teams. These four subtasks collectively provide a comprehensive approach to detecting and addressing potential fraud.

In response to determining that the task includes the plurality of subtasks, in further embodiments, the process 900 may select a corresponding AI agent, from the subset of AI agents, for each subtask of the plurality of subtasks (block 970). For example, if the task includes two subtasks, such as a data processing subtask and a data analysis subtask, the process 900 may select one AI agent for the data processing subtask, and another AI agent for the data analysis subtask. This ensures that different aspects of the task are handled by specialized AI agents, leveraging their individual strengths, and optimizing the overall execution efficiency. In an example, if the task includes multiple subtasks, the process 900 may assign each subtask to the most suitable AI agent, considering the expertise, capabilities, and availability of the AI agents. This ensures that the task is executed efficiently.

In response to determining that the task does not include the plurality of subtasks, in further embodiments, the process 900 may select two or more AI agents, from the subset of AI agents, for parallel execution of the task (block 980). In cases where the task is large or complex and needs to be processed in parallel, the process 900 may assign the task to multiple AI agents simultaneously to optimize resources and improve execution speed.

In additional embodiments, the process 900 may assign the plurality of subtasks or the task (block 990). In numerous embodiments, the process 900 may assign each subtask of the plurality of subtasks to the selected corresponding AI agent. In numerous additional embodiments, the process 900 may assign the task to the two or more AI agents for parallel execution.

Although a specific embodiment for the process 900 for assigning the task or subtasks to the AI agents based on the reputation scores of the AI agents suitable for carrying out the various steps, processes, methods, and operations described herein is discussed with respect to FIG. 9, any of a variety of systems and/or processes may be utilized in accordance with embodiments of the disclosure. For example, after the plurality of subtasks or the task have been assigned, the process 900 may monitor a collaborative execution of the plurality of subtasks or monitor an execution of the task by each of the two or more AI agents. The elements depicted in FIG. 9 may also be interchangeable with other elements of FIGS. 1-8 and FIG. 10-13 as required to realize a particularly desired embodiment.

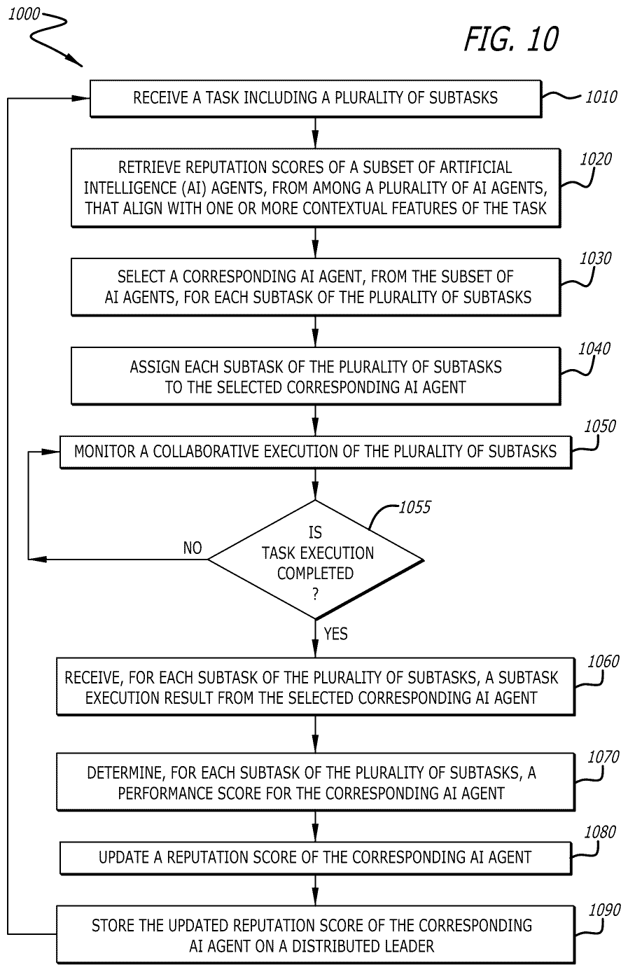

Referring to FIG. 10, a flowchart depicting a process 1000 for collaborative task execution involving distribution of subtasks among AI agents and updating of reputation scores of the AI agents based on performance in accordance with various embodiments of the disclosure is shown. Collaborative task execution may refer to a process where multiple AI agents work together to complete a set of subtasks. Each AI agent may have specialized capabilities, expertise, or resources, and by collaborating, the AI agents can collectively achieve better performance, efficiency, or accuracy than if a single AI agent were to handle the entire task.

In a variety of embodiments, the process 1000 may receive a task including a plurality of subtasks (block 1010). In one or more embodiments, the process 1000 may receive the task from an external system, which could be a business system, an Enterprise Resource Planning (ERP) platform, or an external software application that generates the task based on certain conditions or triggers. In various embodiments, the process 100 may receive the task submitted through a user input, where a system administrator manually provides the task, for example through a user interface or control panel.

In further embodiments, the process 1000 may retrieve reputation scores of a subset of AI agents, from among a plurality of AI agents, that align with one or more contextual features associated with the task (block 1020). The one or more contextual features may represent key attributes or characteristics of the task that guide how the task should be assigned, carried out, and managed. Examples of the contextual features may include a task type, specific requirements associated with the task, or any security considerations. A reputation score may be a numerical or qualitative measure reflecting the historical task execution results of an AI agent, providing insights into its performance, reliability, and trustworthiness. For example, a reputation score of a first AI agent being lower than a reputation score of a second AI agent may indicate potential weaknesses or inconsistencies of the first AI agent as compared to the second AI agent. However, a reputation score of the first AI agent being greater than a reputation score of the second AI agent may signify strong performance and reliability by the first AI agent as compared to the second AI agent. The reputation scores may play a key role in decision-making, especially when selecting AI agents for future tasks, as the reputation scores offer valuable information about past behaviour and capabilities of the AI agents. In some embodiments, the process 1000 may retrieve the reputation scores of the subset of AI agents from a database.

In still yet more embodiments, the process 1000 may select a corresponding AI agent, from the subset of AI agents, for each subtask of the plurality of subtasks (block 1030). In an embodiment, the process 1000 may select the corresponding AI agent, from the subset of AI agents, for each subtask of the plurality of subtasks based on the retrieved reputation scores. The selection may be based on evaluating the historical performance and reliability of the subset of AI agents, as indicated by their reputation scores, and matching them to specific subtasks that align with their strengths and past successes. For example, if the task includes a subtask involving complex data analysis, the process 1000 may prioritize an AI agent with a high reputation score for its past success in data-analysis related tasks. If another subtask involves time-sensitive decision-making, the process 1000 may select an AI agent known for executing tasks efficiently and accurately under time constraints. By leveraging the reputation scores, the process 1000 may ensure that each AI agent selected for a subtask has demonstrated consistent capability in handling similar tasks, thus optimizing the chances of success for the entire task.

In numerous additional embodiments, the process 1000 may assign each subtask of the plurality of subtasks to the selected corresponding AI agent (block 1040). Once the most appropriate AI agents have been selected for each subtask, based on factors such as reputation scores, the process 1000 may proceed to assign the subtasks to the respective AI agents for execution. Assigning each subtask to the selected corresponding AI agent based on the reputation scores may enhance efficiency and accuracy by ensuring that the subtasks are handled by the most capable AI agents for specific subtasks. This approach may optimize resource allocation, reduce bottlenecks, and improve overall task execution.

In a number of embodiments, the process 1000 may monitor a collaborative execution of the plurality of subtasks (block 1050). The process 1000 may track the progress of each AI agent in real-time or near real-time, identifying any potential delays or issues, and ensuring that the subtasks are being executed according to the task requirements. By continuously overseeing the execution process, the process 1000 may detect any discrepancies or inefficiencies, enabling timely interventions to maintain smooth and effective collaboration among the AI agents. In an example, collaborative execution of the plurality of subtasks may involve ensuring that a subtask execution result of one AI agent is promptly provided to another AI agent when dependencies exist between the two AI agents. Additionally, the process 1000 may facilitate real-time communication between the selected AI agents by enabling an integrated interface for information exchange, allowing the selected AI agents to work in conjunction.

In many further embodiments, the process 1000 may determine whether the execution of the task has been completed (block 1055). In a variety of embodiments, the process 1000 may check if each subtask assigned to the selected AI agent has been successfully finished. Only when all subtasks are complete, and the task as a whole has been executed according to the task requirements, the process 1000 may establish that the task is completed.

In response to determining that the execution of the task has not yet been completed, in further additional embodiments, the process 1000 may continue to monitor the collaborative execution of the plurality of subtasks (block 1050). In an embodiment, the process 1000 may regularly check the progress of each AI agent involved in the task or subtasks.

In response to determining that the execution of the task is complete, in further embodiments, the process 1000 may receive, for each subtask of the plurality of subtasks, a subtask execution result from the selected corresponding AI agent (block 1060). A subtask execution result may refer to the outcome or performance data provided by an AI agent upon completing an assigned subtask. The subtask execution result may include various metrics, such as the completion status (success or failure), the time taken to complete the subtask, the accuracy of the execution, resource utilization, and whether the subtask met the predefined criteria or requirements. In more embodiments, the process 1000 may transmit a query to each selected corresponding AI agent to retrieve the subtask execution result for each subtask of the plurality of subtasks.

In still more embodiments, the process 1000 may determine, for each subtask of the plurality of subtasks, a performance score for the corresponding AI agent (block 1070). The performance score may provide a comprehensive assessment of how effectively each AI agent handled the assigned subtask, offering valuable insights into their performance and enabling future improvements or adjustments. The process 1000 may determine the performance score for the corresponding AI agent based one or more determination parameters. The one or more determination parameters may include one or more of an actual task execution time or an actual resource efficiency.

In some more embodiments, the process 1000 may update a reputation score of the corresponding AI agent (block 1080). In yet more embodiments, the process 1000 may update the reputation score of the corresponding AI agent based on the determined performance score. For example, if the corresponding AI agent successfully completed the subtask with an efficiency greater than a baseline efficiency threshold and within the expected time frame, the process 1000 may increase the reputation score of the corresponding AI agent to reflect improved performance and reliability. On the other hand, if the of the corresponding AI agent failed to meet specific performance criteria, such as exceeding time limits or with an efficiency lower than the baseline efficiency threshold, the process 1000 may decrease the reputation score of the corresponding AI agent, indicating areas for improvement. The updated reputation score may serve as a critical indicator of the of the corresponding AI agent's overall performance history, which can influence future task assignments.

In still yet more embodiments, the process 1000 may store the updated reputation score of the corresponding AI agent on a distributed ledger (block 1090). A distributed ledger may be a decentralized database system where data is replicated across multiple nodes or devices, making the data resistant to data tampering, and enhancing reliability.

Although a specific embodiment for a process for collaborative task execution involving distribution of subtasks among AI agents and updating of reputation scores of the AI agents based on performance suitable for carrying out the various steps, processes, methods, and operations described herein is discussed with respect to FIG. 10, any of a variety of systems and/or processes may be utilized in accordance with embodiments of the disclosure. For example, the process 1000 may identify the subset of AI agents from the plurality of AI agents based on the one or more contextual features associated with the task. The process 1000 may evaluate and filter the plurality of AI agents by assessing their operational context and current availability in relation to the one or more contextual features of the task. The elements depicted in FIG. 10 may also be interchangeable with other elements of FIGS. 1-9 and FIG. 11-13 as required to realize a particularly desired embodiment.

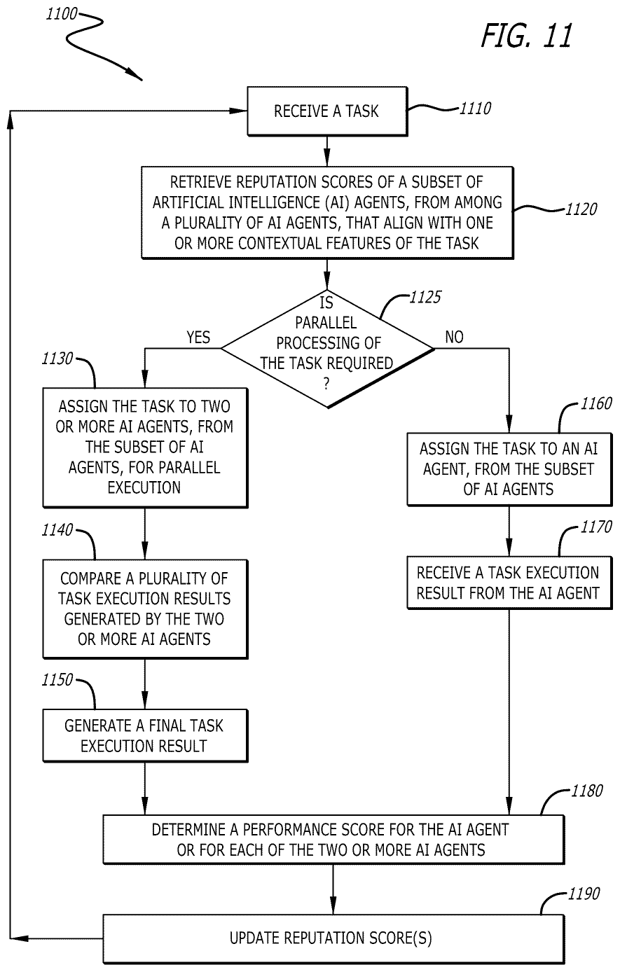

Referring to FIG. 11, a flowchart depicting a process 1100 for assigning tasks to AI agents for parallel processing, comparing task execution results, and updating reputation scores of the AI agents in accordance with various embodiments of the disclosure is shown. Parallel processing may refer to simultaneous execution of a single task by multiple AI agents, where each AI agent independently processes the entire task using different methods or approaches. For example, if the task is a fraud detection operation, different AI agents may independently execute the task using various algorithms or models. One AI agent may use a statistical approach, and another AI agent may use a deep learning model to execute the task.

In a variety of embodiments, the process 1100 may receive a task (block 1110). An example of the task may include a fraud detection operation, where network data is to be analyzed to identify fraudulent activities within a network system. In one or more embodiments, the process 1100 may receive the task from an external enterprise.

In further embodiments, the process 1100 may retrieve reputation scores of a subset of AI agents, from among a plurality of AI agents, that align with one or more contextual features associated with the task (block 1120). Examples of the one or more contextual features may include task type, specific requirements associated with the task, or any security considerations. A reputation score may be a numerical or qualitative measure reflecting the historical task execution results of an AI agent, providing insights into the performance, reliability, and trustworthiness of the AI agent. In various embodiments, the process 1100 may retrieve the reputation scores of the subset of AI agents from a database.

In several embodiments, the process 1100 may determine whether parallel processing of the task is required (block 1125). The determination may be based on various factors, such as the complexity of the task, the required accuracy level, the reputation scores of the subset of AI agents, the required processing speed, or the like. For example, if the task involves a large dataset or requires complex analysis, parallel processing may be necessary to improve efficiency and speed. In another example, if the reputation scores of the subset of AI agents exceed a predefined baseline threshold, the process 1100 may establish that the subset of AI agents are reliable, reducing the need for additional verification steps. However, if the reputation scores of the subset of AI agents are below the predefined baseline threshold, the process 1100 may employ parallel processing to cross-verify outputs from multiple AI agents, ensuring greater accuracy and robustness in the results.

In response to determining that parallel processing of the task is required, in one or more embodiments, the process 1100 may assign the task to two or more AI agents, from the subset of AI agents, for parallel execution (block 1130). In yet various embodiments, the two or more AI agents may be selected based on factors such as expertise, reputation scores, or alignment with the one or more contextual features of the task. The parallel execution of the task may enable the process 1100 to leverage the expertise of each of the two or more AI agents, reduce processing time, and potentially improve the overall accuracy of the task.

In additional embodiments, the process 1100 may compare a plurality of task execution results generated by the two or more AI agents (block 1140). After the two or more AI agents independently complete the task, each of the two or more AI agents may generate a task execution result. In more embodiments, the process 1100 may aggregate and compare the plurality of task execution results to identify any discrepancies, variations, or agreement between the two or more AI agents. This comparison may allow the process 1100 to assess the consistency and reliability of output generated by the two or more AI agents. For example, if the task involves identifying fraudulent data packets, the two or more AI agents may have detected different sets of potentially fraudulent data packets. The process 1100 may compare these sets to determine which task execution results are most likely to be accurate and align with the overall task requirements.

In various additional requirements, the process 1100 may generate a final task execution result (block 1150). In yet more embodiments, the process 1100 may generate the final task execution result based on the comparison of the plurality of execution results. The final task execution result may be generated by evaluating and aggregating the plurality of execution results into a single result. The process 1100 may generate the final execution result based on decision-making algorithms, statistical methods, or weighted averages. For example, if the task involved classifying data, and the two or more AI agents produced different classifications, the process 1100 may compare the classifications and, depending on predefined rules, select the most accurate or reliable classification as the final task execution result. In further examples, the process 1100 may merge the classifications depending on predefined rules to generate a merged classification as the final task execution result.

In response to determining that parallel processing of the task is not required, in one or more embodiments, the process 1100 may assign the task to an AI agent, from the subset of AI agents (block 1160). For example, when the task is relatively simple, such as basic data entry or straightforward processing, parallel processing may not provide any additional benefit. In such cases, the process 1100 may select a single AI agent to efficiently complete the task independently, without the need for distribution across multiple AI agents. In further example, if the reputation scores of the subset of AI agents exceed the predefined baseline threshold, the process 1100 may select one of the subset of AI agents for independent task execution, without the need for distribution across multiple AI agents.

In yet several embodiments, the process 1100 may receive a task execution result from the AI agent (block 1170). The task execution result may refer to the outcome or report generated by the AI agent after completing the task. In many examples, the task execution result may include completion status (e.g., success or failure), accuracy of the task output, time taken to complete the task, resource utilization (e.g., CPU, memory, or network usage), and adherence to predefined requirements (e.g., meeting quality standards, deadlines, or specific conditions).

In a number of embodiments, the process 1100 may determine a performance score for the AI agent or for each of the two or more AI agents (block 1180). The performance score may be a quantitative measure used to evaluate the effectiveness and efficiency of an AI agent in completing the assigned task. In an embodiment, the process 1100 may determine the performance score for the AI agent based on the task execution result received from the AI agent. In some embodiments, the process 1100 may determine the performance score for each of the two or more AI agents based on respective task execution results.

In still more embodiments, the process 1100 may update reputation score(s) (block 1190). In still yet more embodiments, the process 1100 may update the reputation score of the AI agent based on corresponding performance score. In many further embodiments, the process 1100 may update the reputation scores of each of the two or more AI agents based on their respective performance scores. For example, an AI agent's reputation score may either increase or decrease depending on the performance of the AI agent during task execution. If the AI agent performed consistently well and met or exceeded expectation thresholds, the reputation score of the AI agent may be increased. On the other hand, if the AI agent's performance is subpar or inefficient, e.g., below the expectation thresholds, the reputation score of the AI agent may be lowered. The updated reputation score may play a key role in future decision-making, as the updated reputation score can influence the selection of the AI agent for subsequent tasks. In other words, updating the reputation scores of the AI agents may serve as a feedback for future task executions and may impact task assignment.

Although a specific embodiment for the process 1100 for assigning tasks to AI agents for parallel processing, comparing task execution results, and updating reputation scores of the AI agents suitable for carrying out the various steps, processes, methods, and operations described herein is discussed with respect to FIG. 11, any of a variety of systems and/or processes may be utilized in accordance with embodiments of the disclosure. For example, after the task is received, the process 1100 may determine the one or more contextual features associated with the task to perform context-aware task assignment. The elements depicted in FIG. 11 may also be interchangeable with other elements of FIGS. 1-10 and FIG. 12-13 as required to realize a particularly desired embodiment.

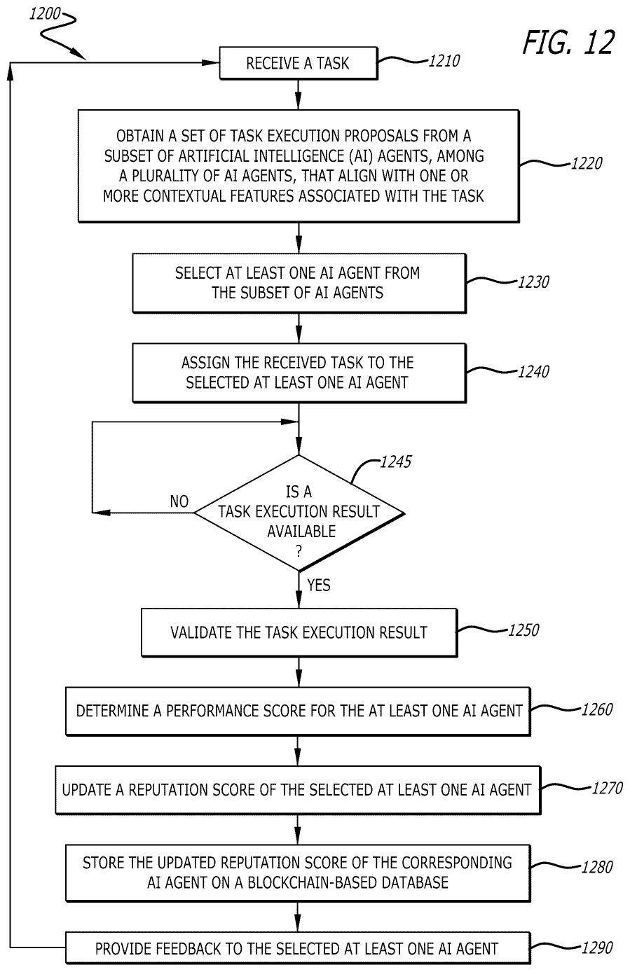

Referring to FIG. 12, a flowchart depicting a process 1200 for assigning tasks to AI agents, validating task execution results, and updating reputation scores of the AI agents on a blockchain-based database in accordance with various embodiments of the disclosure is shown. In many embodiments, a task may refer to an operation that can be assigned to one or more AI agents for autonomous execution, without human intervention, with the goal of achieving a specific outcome, such as processing, computation, or service delivery.

In a variety of embodiments, the process 1200 may receive a task (block 1210). The task may be received for assignment to one or more AI agents from among a plurality of AI agents. In several embodiments, the process 1200 may receive the task from an external source. Examples of the external source include, but are not limited to, an external system, a user input, an external Application Programming Interface (API), or a web service. In various embodiments, the process 1200 may create the task itself, rather than receiving the task from the external source. For instance, the process 1200 may generate the task in response to specific events or triggers, such as arrival of new data, completion of a prior task, or detection of an issue within a system.

In further embodiments, the process 1200 may obtain a set of task execution proposals from a subset of AI agents, among the plurality of AI agents, that align with one or more contextual features associated with the task (block 1220). The one or more contextual features may refer to specific characteristics or attributes related to the task that influence how the task should be assigned, executed, and/or managed. In examples, the one or more contextual features may correspond to at least one of a task type, one or more requirements of the task, or security requirements. Further, a task execution proposal may represent a bid from an AI agent, in which the AI agent outlines the proposed strategy for executing a task. The task execution proposal may include an approach suggested by the AI agent to fulfil the task, such as the execution method, expected duration, reputation score, required computational resources, and any associated costs. In several embodiments, the process 1200 may transmit a query to the subset of AI agents for submission of the set of task execution proposals for the received task, where the set of task execution proposals is obtained as a response from the subset of AI agents for the transmitted query.

In further additional embodiments, the process 1200 may select at least one AI agent from the subset of AI agents (block 1230). The selection may be based on an evaluation of the set of task execution proposals. In many embodiments, the process 1200 may evaluate the obtained set of task execution proposals against c. These evaluation parameters may include, but are not limited to, a task execution time, a task execution cost, resource efficiency, and a reputation score. In some embodiments, the process 1200 may compare the task execution proposals received from the subset of AI agents and select the most suitable task execution proposal and the corresponding AI agent. The most suitable task execution proposal can be defined as the task execution proposal that outperforms others across the one or more evaluation parameters, demonstrating superior alignment with the task.

In a number of embodiments, the process 1200 may assign the received task to the selected at least one AI agent (block 1240). In various embodiments, the process 1200 may assign the received task to the selected at least one AI agent based on capabilities and current operational state of the selected at least one AI agent, ensuring alignment with the specific requirements of the task. By assigning the task to the most suitable AI agent, the overall accuracy and efficiency of task execution may be enhanced.

In yet several embodiments, the process 1200 may determine whether a task execution result is available (block 1245). The task execution result may refer to the outcome or report provided by the selected at least one AI agent after completing the assigned task. The task execution result may include various metrics that reflect how the task was performed, such as the completion status (success or failure), the actual time taken to complete the task, resource utilization, and adherence to predefined task requirements or performance criteria. In numerous embodiments, the process 1200 may determine whether the task execution result is available based on whether the task execution result has been received from the selected at least one AI agent. In some more embodiments, the process 1200 may send a query to the selected at least one AI agent submission of the task execution result.

In response to determining that the task execution result is not available, the process 1200 may continue to determine whether the task execution result is available (block 1245). The process 1200 may repeatedly check whether the task execution result has been received from the selected at least one AI agent. If the result is still unavailable, the process 1200 may wait for a specified time period or reattempt to query the selected at least one AI agent for the task execution result.

In response to determining that the task execution result is available, in one or more embodiments, the process 1200 may validate the task execution result (block 1250). In more embodiments, the process 1200 may validate the task execution result against one or more validation parameters. The one or more validation parameters may include compliance with one or more task requirements of the task or a task execution accuracy. For example, if the task involves processing large data sets, the validation parameter may include ensuring that the task was completed within the allocated time frame and did not exceed the designated memory usage. Additionally, the task execution result may be validated for task execution accuracy. For example, if the task is a fraud detection operation, the accuracy of the task execution result in identifying fraudulent data packets would be critical. In this case, the validation parameter may include assessing the number of true positive fraud detections compared to false positives, ensuring that the selected at least one AI agent accurately identifies fraud without flagging legitimate data packets unnecessarily.

In still more embodiments, the process 1200 may determine a performance score for the selected at least one AI agent (block 1260). The performance score may provide a numerical value or rating that reflects how effectively and efficiently the selected at least one AI agent completed the assigned task. The process 1200 may determine the performance score for the selected at least one AI agent based on the validation of the task execution result and one or more determination parameters. The one or more determination parameters may include one or more of an actual task execution time or an actual resource efficiency. For example, if the task is a fraud detection operation that was supposed to be completed within 3 hours, however, the selected at least one the AI agent executed the task in 4 hours, then the process 1200 may determine the performance score to be 80 out of 100.

In still more embodiments, the process 1200 may update a reputation score of the selected at least one AI agent (block 1270). In still yet more embodiments, the process 1200 may update the reputation score of the selected at least one AI agent based on the determined performance score. The reputation score may be a numerical value or rating that reflects the past performance of the selected at least one AI agent and helps assess the reliability for future tasks. The updated reputation score can influence the selection of the selected at least one AI agent for future tasks, ensuring that AI agents with higher reliability and proven efficiency are given preference. For example, if the task was a fraud detection operation and the selected at least one AI agent completed the task with high accuracy but took longer than expected, the performance score of the selected at least one AI agent may reflect a reduction due to the delayed task completion. Suppose the selected at least one AI agent initially had a reputation score of 85. After the performance score is determined to be lower, for example, 80 out of 100, the process 1200 may update the reputation score of the selected at least one agent from 85 to 83. This adjustment may reflect a decrease in the reliability of the selected at least one AI agent based on the time taken to complete the task.

In many further embodiments, the process 1200 may store the updated reputation score of the selected at least one AI agent on a blockchain-based database (block 1280). In numerous additional embodiments, the process 1200 may store the updated reputation score of the at least one AI agent on a distributed ledger which may correspond to the blockchain-based database. A distributed ledger may be a decentralized database system where data is replicated across multiple nodes or devices, making the data resistant to data tampering, and enhancing reliability. The blockchain-based database may ensure that once the reputation score is recorded, the reputation score cannot be altered or tampered with, providing a reliable and verifiable record of the performance history of the selected at least one AI agent. In an example, the process 1200 may access the blockchain-based database by integrating with an API associated with the blockchain-based database or smart contracts associated with the blockchain-based database. The process 1200 can query the blockchain-based database for reputation scores, verify the authenticity of the reputation scores using cryptographic signatures, and update the reputation scores by invoking specific smart contract functions. Access control to the blockchain-based database can be managed through blockchain-based authentication mechanisms, ensuring that only authorized entities interact with the blockchain-based database.

In further embodiments, the process 1200 may provide feedback to the selected at least one AI agent (block 1290). The process 1200 may provide the feedback in the form of a performance report that includes insights regarding task execution time, resource efficiency, accuracy, and adherence to predefined requirements. The selected at least one AI agent may use the feedback to adjust decision-making processes, thereby improving future performance. In many additional embodiments, the feedback may be automated and delivered directly to the selected at least one AI agent through a dedicated feedback loop, allowing the selected at least one AI agent to learn from previous task execution and refine its processes. In further additional embodiments, the feedback may be more interactive, enabling system administrators to provide recommendations based on the task execution result. By consistently providing feedback, the process 1200 may enable the selected at least one AI agent to improve its capabilities, adapt to changing task requirements, and increase efficiency over time.

Although a specific embodiment for the process 1200 for assigning tasks to AI agents, validating task execution results, and updating reputation scores of the AI agents on a blockchain-based database suitable for carrying out the various steps, processes, methods, and operations described herein is discussed with respect to FIG. 12, any of a variety of systems and/or processes may be utilized in accordance with embodiments of the disclosure. For example, the selected at least one AI agent may include two or more AI agents of the subset of AI agents. The process 1200 may assign the task to the two or more AI agents for parallel execution, monitor an execution of the task by each of the two or more AI agents, receive a plurality of task execution results from the two or more AI agents based on the execution of the task, compare the plurality of task execution results. and generate a final task execution result based on the comparison. Further, the process 1200 may execute one or more interactions with the selected at least one AI agent using one or more smart contracts. The elements depicted in FIG. 12 may also be interchangeable with other elements of FIGS. 1-11 and FIG. 13 as required to realize a particularly desired embodiment.

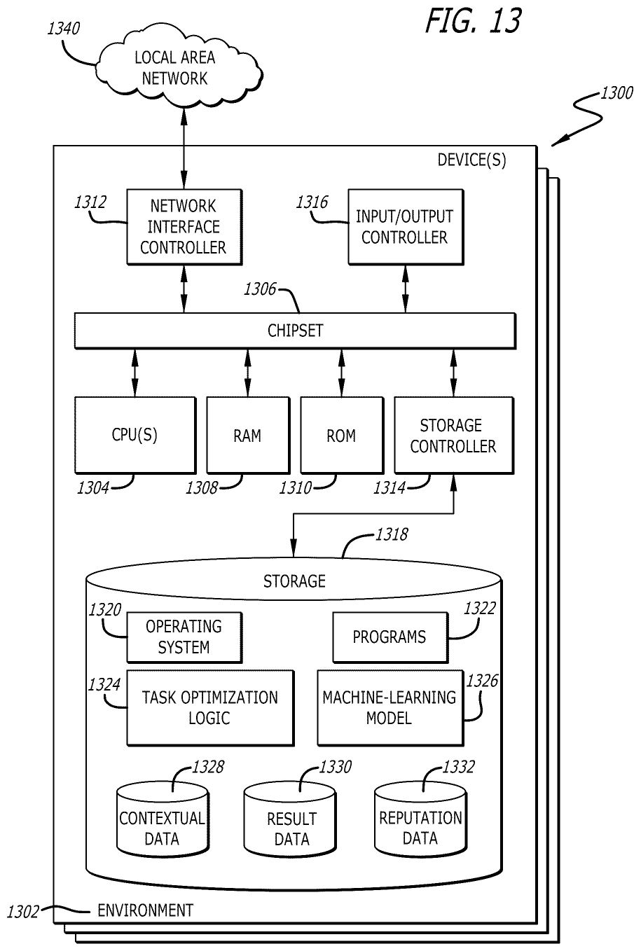

Referring to FIG. 13, a conceptual block diagram of a device 1300 capable of executing components and a task optimization logic 1324 for implementing the functionality and embodiments described above is shown. The embodiment of the conceptual block diagram depicted in FIG. 13 can illustrate a conventional server computer, a workstation, a desktop computer, a laptop, a tablet, a network appliance, an electronic reader (e-reader), a smartphone, or other computing device, and can be utilized to execute any of the application and/or logic components presented herein. The device 1300 may, in some examples, correspond to a physical device or to a virtual resource described herein. The device 1300 can be a network device (for example, an access point, a switch, or a controller), a client device, or the like in accordance with various embodiments of the disclosure.

In many embodiments, the device 1300 may include an environment 1302 such as a baseboard or a “motherboard,” in physical embodiments that can be configured as a printed circuit board with a multitude of components or devices connected by way of a system bus or other electrical communication paths. Conceptually, in virtualized embodiments, the environment 1302 may be a virtual environment that encompasses and executes the remaining components and resources of the device 1300. In a number of embodiments, one or more processors 1304, such as, but not limited to, central processing units (CPUs) can be configured to operate in conjunction with a chipset 1306. The processor(s) 1304 can be standard programmable CPUs that perform arithmetic and logical operations necessary for the operation of the device 1300.

In a variety of embodiments, the processor(s) 1304 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1306 may provide an interface between the processor(s) 1304 and the remainder of the components and devices within the environment 1302. The chipset 1306 can provide an interface to a random-access memory (RAM) 1308, which can be utilized as the main memory in the device 1300 in some embodiments. The chipset 1306 can further be configured to provide an interface to a computer-readable storage medium such as a read-only memory (ROM) 1310 or a Non-Volatile RAM (NVRAM) for storing basic routines that can help with various tasks such as, but not limited to, starting up the device 1300 and/or transferring information between the various components and devices. The ROM 1310 or NVRAM can also store other application components necessary for the operation of the device 1300 in accordance with various embodiments described herein.

Different embodiments of the device 1300 can be configured to operate in a networked environment using logical connections to remote computing devices and computer systems through a network, such as the network 1340. The chipset 1306 can include functionality for providing network connectivity through a Network Interface Controller (NIC) 1312, which may include a gigabit Ethernet adapter or similar component. The NIC 1312 can be capable of connecting the device 1300 to other devices over the network 1340. It is contemplated that multiple NICs 1312 may be present in the device 1300, connecting the device 1300 to other types of networks and remote systems.

In more embodiments, the device 1300 can be connected to a storage 1318 that provides non-volatile storage for data accessible by the device 1300. The storage 1318 can, for example, store an operating system 1320, programs 1322, contextual data 1328, result data 1330, and reputation data 1332, which are described in greater detail below. The storage 1318 can be connected to the environment 1302 through a storage controller 1314 connected to the chipset 1306. In additional embodiments, the storage 1318 can include one or more physical storage units. The storage controller 1314 can interface with the physical storage units through a Serial Advanced Technology Attachment (SATA) interface, a Fiber Channel (FC) interface, a Serial Attached SCSI (SAS) interface, where SCSI refers to a Small Computer System Interface, or other type of interface for physically connecting and transferring data between computers and physical storage units.

The device 1300 can store data within the storage 1318 by transforming the physical state of the physical storage units to reflect the information being stored. The specific transformation of physical state can depend on various factors. Examples of such factors can include, but are not limited to, the technology utilized to implement the physical storage units, whether the storage 1318 is characterized as primary or secondary storage, and the like. For example, the device 1300 can store information within the storage 1318 by issuing instructions through the storage controller 1314 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1300 can further read or access information from the storage 1318 by detecting the physical states or characteristics of one or more particular locations within the physical storage units.

In addition to the storage 1318 described above, the device 1300 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1300. In some examples, the operations performed by a cloud computing network, and or any components included therein, may be supported by one or more devices similar to the device 1300. Stated otherwise, some or all of the operations performed by the cloud computing network, and or any components included therein, may be performed by one or more devices 1300 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, Erasable programmable ROM (EPROM), Electrically-Erasable programmable ROM (EEPROM), flash memory or other solid-state memory technology, Compact Disc-ROM (CD-ROM), Digital Versatile Disk (DVD), High Definition DVD (HD-DVD), BLU-RAY, or other optical storage, magnetic cassettes, magnetic tape, magnetic disk storage or other magnetic storage devices, or any other medium that can be utilized to store the desired information in a non-transitory fashion.

As mentioned briefly above, the storage 1318 can store an operating system 1320 utilized to control the operation of the device 1300. According to one embodiment, the operating system 1320 includes the LINUX operating system. According to another embodiment, the operating system 1320 includes the Windows® server operating system from Microsoft Corporation of Redmond, Washington. According to further embodiments, the operating system 1320 can include the UNIX operating system or one of its variants. It should be appreciated that other operating systems can also be utilized. The storage 1318 can store other system or application programs and data utilized by the device 1300.

In still more embodiments, the storage 1318 or other computer-readable storage media is encoded with computer-executable instructions which, when loaded into the device 1300, may transform the device 1300 from a general-purpose computing system into a special-purpose computer capable of implementing the embodiments described herein. These computer-executable instructions may be stored as programs 1322 (e.g., applications) and transform the device 1300 by specifying how the processor(s) 1304 can transition between states, as described above. In still further embodiments, the device 1300 has access to computer-readable storage media storing computer-executable instructions which, when executed by the device 1300, perform the various processes described above with regard to FIGS. 1-13. In still additional embodiments, the device 1300 can also include computer-readable storage media having instructions stored thereupon for performing any of the other computer-implemented operations described herein.

In some more embodiments, the device 1300 can also include one or more input/output controllers 1316 for receiving and processing input from a number of input devices, such as a keyboard, a mouse, a touchpad, a touch screen, an electronic stylus, or other type of input device. Similarly, an input/output controller 1316 can be configured to provide output to a display, such as a computer monitor, a flat panel display, a digital projector, a printer, or other type of output device. Those skilled in the art will recognize that the device 1300 may not include all of the components shown in FIG. 13, and can include other components that are not explicitly shown in FIG. 13, or may utilize an architecture completely different than that shown in FIG. 13.

As described above, the device 1300 may support a virtualization layer, such as one or more virtual resources executing on the device 1300. In some examples, the virtualization layer may be supported by a hypervisor that provides one or more virtual machines running on the device 1300 to perform functions described herein. The virtualization layer may generally support a virtual resource that performs at least a portion of the techniques described herein.

In yet various embodiments, the device 1300 can include a task optimization logic 1324 that may be responsible for allocating tasks to a plurality of AI agents and manage task execution. In yet more embodiments, the task optimization logic 1324 may operate in the controller. In embodiments where the device 1300 corresponds to the controller, the task optimization logic 1324 can be configured to perform various operations such as, but not limited to, receiving a task; determining one or more contextual features associated with the task; obtaining a set of task execution proposals from a subset of AI agents, among a plurality of AI agents, that align with the determined one or more contextual features; evaluating the obtained set of task execution proposals against one or more evaluation parameters, selecting at least one AI agent from the subset of AI agents based on the evaluation of the set of task execution proposals; and assigning the received task to the selected at least one AI agent. In embodiments where the device 1300 corresponds to a network device, for example, an access point, the task optimization logic 1324 can be configured to perform various operations such as, but not limited to, transmitting a query to the subset of AI agents for submission of the set of task execution proposals for the received task and receiving the set of task execution proposals as a response from the subset of AI agents for the transmitted query.

Those skilled in the art will recognize that the task optimization logic 1324 can include various hardware and/or software deployments and can be configured in a variety of ways. In still yet more embodiments, the task optimization logic 1324 can be configured as a standalone device, exist as a logic in another network device, be distributed among various network devices operating in tandem, or remotely operated as part of a cloud-based network management tool. In many further embodiments, one or more servers can be configured with the task optimization logic 1324 or can otherwise operate as the task optimization logic 1324. In many additional embodiments, the task optimization logic 1324 may operate on one or more servers connected to a communication network, for example, the Internet. The communication network can include wired networks or wireless networks. The task optimization logic 1324 can be provided as a cloud-based service that can service remote networks, such as, but not limited to a deployed network. Further, in still yet further embodiments, the task optimization logic 1324 may be operated as a distributed logic across multiple network devices. In an embodiment, the control plane node can operate as the task optimization logic 1324 or may have multiple devices operate as the task optimization logic 1324 in a distributed manner.

In several embodiments, the storage 1318 can include contextual data 1328. The contextual data 1328 may relate to one or more contextual features associated with tasks. For example, the contextual data 1328 may include, but are not limited to, task types, task specific requirements, and security requirements. In further additional embodiments, the contextual data 1328 may be utilized by the task optimization logic 1324 to identify a subset of AI agents, from the plurality of AI agents, that align with contextual features associated with the task.

In several more embodiments, the storage 1318 can include result data 1330. The result data 1330 may relate to task execution results provided by AI agents after completing assigned tasks or subtasks. The result data 1330 can include, but is not limited to, a completion status (success or failure), actual time taken to complete the task, resource utilization, and adherence to any predefined task requirements or performance criteria. In several embodiments, in addition to the contextual data 1328, the result data 1330 may be utilized by the task optimization logic 1324 to evaluate performance of the AI agents.

In numerous embodiments, the storage 1318 can include reputation data 1332. The reputation data 1332 may relate to reputation scores of the AI agents. A reputation score refers to a numerical value or rating that represents an AI agent's past performance, derived from historical task executions. For example, the reputation data 1332 may include reputation scores of AI agents.

In numerous additional embodiments, data may be processed into a format usable by a machine-learning (“ML”) model 1326 (e.g., feature vectors), and or other preprocessing techniques. The ML model 1326 may be any type of ML model, such as supervised models, reinforcement models, and/or unsupervised models. The ML model 1326 may include one or more of linear regression models, logistic regression models, decision trees, Naïve Bayes models, neural networks, k-means cluster models, random forest models, and/or other types of ML models. The ML model 1326 may be configured to analyze the contextual data 1328, the result data 1330, and the reputation data 1332 for performing task allocation and management. In further additional embodiments, the ML model 1326 may be utilized to identify various parameters to include in the contextual data 1328, the result data 1330, and the reputation data 1332. For example, the ML model 1326 may analyze the contextual data 1328, the result data 1330, and the reputation data 1332 and identify parameters that are required to augment the contextual data 1328, the result data 1330, and the reputation data 1332. Once the parameters are identified, the task optimization logic 1324 may utilize the parameters to perform task assignment and management. For example, the ML model 1326 may be configured to receive the contextual data 1328, the result data 1330, and the reputation data 1332. The task optimization logic 1324 may then utilize trained models to perform context-aware task allocation and reputation management for AI agents.

Although a specific embodiment for a device 1300 capable of executing components and the task optimization logic 1324 for implementing the functionality and embodiments suitable for carrying out the various steps, processes, methods, and operations described herein is discussed with respect to FIG. 13, any of a variety of systems and/or processes may be utilized in accordance with embodiments of the disclosure. For example, the device may be implemented in a virtual environment such as a cloud-based network administration suite or a cloud computing environment, or the device may be distributed across a variety of network devices such that each acts as a device and the task optimization logic 1324 acts in tandem between the devices. The elements depicted in FIG. 13 may also be interchangeable with other elements of FIGS. 1-12 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary”, or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A task management device, comprising:
a processor; and
a memory communicatively coupled to the processor, wherein the memory comprises a task optimization logic that is configured to:
receive a task;
determine one or more contextual features associated with the task;
obtain a set of task execution proposals from a subset of Artificial Intelligence (AI) agents, among a plurality of AI agents, that align with the determined one or more contextual features;
evaluate the obtained set of task execution proposals against one or more evaluation parameters;
select at least one AI agent from the subset of AI agents based on the evaluation of the set of task execution proposals; and
assign the received task to the selected at least one AI agent.

2. The task management device of claim 1, wherein the task optimization logic is further configured to:
identify, from the plurality of AI agents, the subset of AI agents based on the determined one or more contextual features; and
transmit a query to the identified subset of AI agents for submission of the set of task execution proposals for the received task, wherein the set of task execution proposals is obtained as a response from the subset of AI agents for the transmitted query.

3. The task management device of claim 1, wherein the task optimization logic is further configured to:
monitor an execution of the assigned task by the selected at least one AI agent;
receive a task execution result from the at least one AI agent based on the execution of the assigned task;
determine a performance score for the at least one AI agent based on the received task execution result and one or more determination parameters; and
update a reputation score of the selected at least one AI agent based on the determined performance score.

4. The task management device of claim 3, wherein the task optimization logic is further configured to store the updated reputation score of the at least one AI agent on a distributed ledger.

5. The task management device of claim 4, wherein the distributed ledger corresponds to a blockchain-based database.

6. The task management device of claim 3, wherein the one or more determination parameters comprises one or more of an actual task execution time or an actual resource efficiency.

7. The task management device of claim 3, wherein the task optimization logic is further configured to validate the task execution result against one or more validation parameters, and wherein the determination of the performance score for the at least one AI agent is further based on the validation of the task execution result.

8. The task management device of claim 7, wherein the one or more validation parameters comprises one or more of compliance with one or more task requirements of the task or a task execution accuracy.

9. The task management device of claim 3, wherein the task optimization logic is further configured to perform one or more interactions with the plurality of AI agents utilizing a smart contract.

10. The task management device of claim 9, wherein the one or more interactions comprise at least one of: a first interaction to obtain a task execution proposal of the set of task execution proposals, a second interaction to assign the received task, a third interaction to monitor the execution of the assigned task, or a fourth interaction to receive the task execution result.

11. The task management device of claim 9, wherein the smart contract comprises one or more terms and conditions associated with the task.

12. The task management device of claim 3, wherein the task optimization logic is further configured to provide feedback to the selected at least one AI agent regarding the execution of the task, and wherein the feedback comprises at least one of the performance score or the updated reputation score.

13. The task management device of claim 1, wherein the selected at least one AI agent comprises two or more AI agents of the subset of AI agents, and wherein the task optimization logic is further configured to:
assign the task to the two or more AI agents for parallel execution;
monitor an execution of the task by each of the two or more AI agents;
receive a plurality of task execution results from the two or more AI agents based on the execution of the task;
compare the plurality of task execution results; and
generate a final task execution result based on the comparison.

14. The task management device of claim 13, wherein the task optimization logic is further configured to:
determine a performance score for each of the two or more AI agents based on the final task execution result and one or more determination parameters; and
update a reputation score of each of the two or more AI agents based on the determined performance score.

15. The task management device of claim 1, wherein the one or more contextual features correspond to at least one of: a task type, one or more requirements of the task, or one or more security requirements.

16. The task management device of claim 1, wherein the one or more evaluation parameters comprises at least one of: a task execution time, a task execution cost, a resource efficiency, or a reputation score.

17. The task management device of claim 1, wherein the plurality of AI agents is deployed in a distributed network architecture.

18. A task management device, comprising:
a processor; and
a memory communicatively coupled to the processor, wherein the memory comprises a task optimization logic that is configured to:
receive a task comprising a plurality of subtasks;
determine one or more contextual features associated with the task;
obtain a set of task execution proposals from a subset of Artificial Intelligence (AI) agents, among a plurality of AI agents, that align with the determined one or more contextual features;
evaluate the obtained set of task execution proposals against a plurality of evaluation parameters;
select a corresponding AI agent, from the subset of AI agents, for each subtask of the plurality of subtasks based on the evaluation of the set of task execution proposals; and
assign each subtask of the plurality of subtasks to the selected corresponding AI agent.

19. The task management device of claim 18, wherein the task optimization logic is further configured to:
monitor a collaborative execution of the plurality of subtasks;
receive, for each subtask of the plurality of subtasks, a subtask execution result from the selected corresponding AI agent;
determine, for each subtask of the plurality of subtasks, a performance score for the corresponding AI agent based on the subtask execution result and one or more determination parameters; and
update a reputation score of the corresponding AI agent based on the determined performance score.

20. A method, comprising:
receiving a task;
determining one or more contextual features associated with the task;
obtaining a set of task execution proposals from a subset of Artificial Intelligence (AI) agents, among a plurality of AI agents, that align with the determined one or more contextual features;
evaluating the obtained set of task execution proposals against one or more evaluation parameters;
selecting at least one AI agent from the subset of AI agents based on the evaluation of the set of task execution proposals; and
assigning one of the received task or a subtask associated with the received task to the selected at least one AI agent.
